(19) United States
(12) Patent Application Publication
(10) Pub. No.: US 2023/0242714 A1
(43) Pub. Date: Aug. 3, 2023

(54) SILOXANE-BASED LIQUID CRYSTALLINE ELASTOMERS WITH DYNAMIC COVALENT BONDS

(71) Applicant: CAMBRIDGE ENTERPRISE LIMITED, Cambridge (GB)

(72) Inventors: Eugene Terentjev, Cambridge (GB); Mohand Saed, Cambridge (GB)

(21) Appl. No.: 17/781,976

(22) PCT Filed: Dec. 2, 2020
(86) PCT No.: PCT/EP2020/084246

§ 371 Date: Jun. 2, 2022

(30) Foreign Application Priority Data
Dec. 3, 2019 (GB) 1917656.9

(51) Int. Cl. C08G 77/52

(52) U.S. Cl. CPC C08G 77/52

(57) ABSTRACT

The present invention relates to a siloxane-based liquid crystalline elastomer, preferably an exchangeable siloxane-based liquid crystalline elastomer, derived from monomers (A1), (B1) and (C1), wherein (C1) is an acyclic or cyclic vinyl siloxane, and (A1) and (B1) have the following formulae:

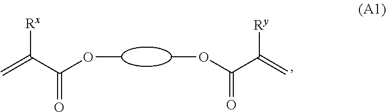

wherein [symbol] is a mesogen, and
R^{x} and R^{y} are independently selected from hydrogen or substituted or unsubstituted C₁₋₁₂ alkyl;

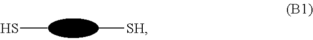

wherein [symbol] is an organic group.

### RELATED APPLICATIONS

This application is a 35 U.S.C. § 371 national stage filing of International Application No. PCT/EP2020/084246, filed on Dec. 2, 2020, which in turn claims the benefit of United Kingdom Application No. 1917656.9, filed on Dec. 3, 2019. The entire contents of each of the foregoing applications are incorporated herein by reference.

The project leading to this application has received funding from the European Research Council (ERC) under the European Union's Horizon 2020 research and innovation programme (grant agreement No 786659).

### FIELD OF THE INVENTION

The present invention relates to a siloxane-based liquid crystalline elastomer, preferably an exchangeable siloxane-based liquid crystalline elastomer, a composition comprising the siloxane-based liquid crystalline elastomer and a catalyst, and methods for the preparation of the composition. The present invention also relates to a moulded article comprising the composition, and to a method of making the moulded article.

### BACKGROUND OF THE INVENTION

Liquid crystalline elastomers (LCEs) are networks composed of long, crosslinked polymer chains that are also liquid crystalline. The natural shape of these polymer chains follow the liquid crystalline order such that LCEs typically elongate in the presence of nematic (orientational order), and reversibly contract when the order is lost. This means that LCEs can undergo reversible shape changes in response to various stimuli (e.g. changes in temperature, changes in lighting, presence of solvent etc.), making them useful as actuators.

LCE actuators are conventionally prepared via a hydrosilylation reaction between siloxane monomers and vinyl mesogens. This process involves the alignment of the LCE by uniaxial stress (often called the polydomain-monodomain transition), and a subsequent two-step crosslinking to produce a permanently aligned (monodomain) capable of actuation. It has, however, proven to be problematic to achieve any useful configuration of siloxane-based elastomers prepared in this way except for uniaxial alignment in a flat film. This is due to the unavoidable limitation of two competing processes: orientation alignment and network crosslinking. Furthermore, the method involves preparing a permanently crosslinked network, meaning that there is no possibility for reshaping the actuator once formed.

Accordingly, there exists a need to prepare new LCEs that can be moulded into a variety of different shapes, and which can be remoulded into different shapes as necessary.

### SUMMARY OF THE INVENTION

Viewed from a first aspect, the present invention provides a siloxane-based liquid crystalline elastomer, preferably an exchangeable siloxane-based liquid crystalline elastomer, derived from monomers (A1), (B1) and (C1), wherein (C1) is an acyclic or cyclic vinyl siloxane, and (A1) and (B1) have the following formulae:

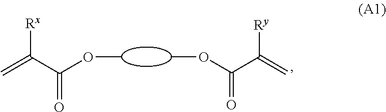

wherein [symbol] is a mesogen, and
R^{x} and R^{y} are independently selected from hydrogen or substituted or unsubstituted C₁₋₁₂ alkyl;

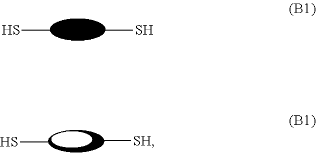

wherein [symbol] is an organic group.

Viewed from a further aspect, the present invention provides a composition comprising a siloxane-based liquid crystalline elastomer, preferably an exchangeable siloxane-based liquid crystalline elastomer, as hereinbefore described, and a catalyst. The catalyst enables the siloxane exchange.

Viewed from a further aspect, the present invention provides a method of preparing a composition as hereinbefore described, comprising:
(i) preparing a mixture comprising monomers of each of formula (A1), (B1), and (C1), wherein (C1) is an acyclic or cyclic vinyl siloxane, and a catalyst:

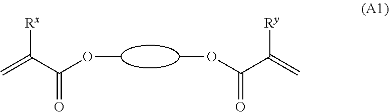

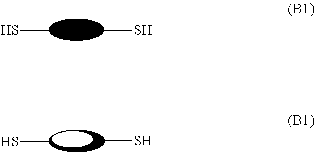

wherein [symbol] R^{x} and R^{y} are as hereinbefore defined;
(ii) polymerising the monomers of formula (A1) and (B1) to give an intermediate reaction mixture comprising a thiol-terminated oligomer, monomers of formula (C1) and a catalyst; and
(iii) photopolymerizing said intermediate reaction mixture to give said composition.

Viewed from a further aspect, the present invention provides a method of preparing a composition as hereinbefore described, comprising:
(i) preparing a mixture comprising monomers of each of formula (B1) and (C1), wherein (C1) is an acyclic or cyclic vinyl siloxane, and optionally a catalyst:

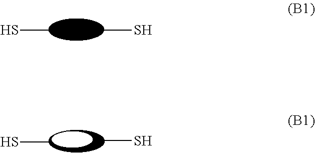

wherein [symbol] is as hereinbefore defined;
(ii) photopolymerizing said mixture to give an intermediate reaction mixture comprising a thiol-terminated siloxane, and optionally a catalyst;
(iii) adding monomers of formula (A1) and optionally a catalyst to said intermediate reaction mixture:

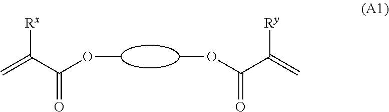

wherein [symbol] R^{x} and R^{y} is as hereinbefore defined; and
(iv) polymerising said intermediate reaction mixture to give said composition, wherein catalyst is added in at least step (i) or step (iii).

Viewed from a further aspect, the present invention provides a composition obtainable by or obtained by a method as hereinbefore described.

Viewed from a further aspect, the present invention provides a siloxane-based liquid crystalline elastomer, preferably an exchangeable siloxane-based liquid crystalline elastomer, derived from monomers (A1), (B1) and (C1), wherein (A1) has a formula selected from

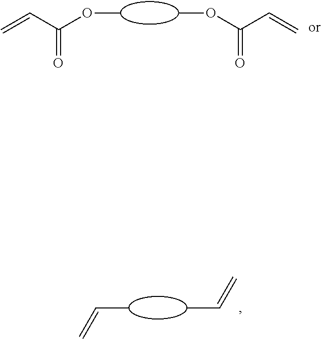

wherein [symbol] is a mesogen;
(B1) has a formula selected from

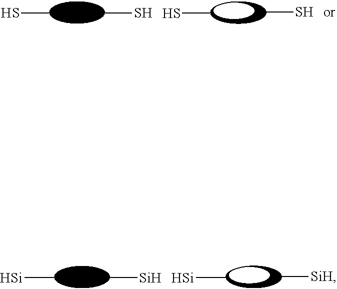

wherein [symbol] is an organic group; and
(C1) is an acyclic or cyclic vinyl siloxane or an acyclic or cyclic thiol siloxane.

Viewed from a further aspect, the present invention provides a composition comprising a siloxane-based liquid crystalline elastomer, preferably an exchangeable siloxane-based liquid crystalline elastomer, as hereinbefore described, and a catalyst.

Viewed from a further aspect, the present invention provides a method of preparing a composition as hereinbefore described, comprising:
(i) preparing a mixture comprising monomers of each of formula (A1), (B1), and (C1) as hereinbefore defined, and a catalyst;
(ii) polymerising the monomers of formula (A1) and (B1) to give an intermediate reaction mixture comprising a thiol-terminated oligomer, an acrylate-terminated oligomer, a vinyl-terminated oligomer, or a silane-terminated oligomer, monomers of formula (C1) and a catalyst; and
(iii) photopolymerizing said intermediate reaction mixture to give said composition.

Viewed from a further aspect, the present invention provides a method of preparing a composition as hereinbefore described, comprising:
(i) preparing a mixture comprising monomers of each of formula (B1) and (C1), as hereinbefore defined, and optionally a catalyst;
(ii) photopolymerizing said mixture to give an intermediate reaction mixture comprising a thiol-terminated siloxane, a vinyl-terminated oligomer, or a silane-terminated siloxane, and optionally a catalyst;
(iii) adding monomers of formula (A1) as hereinbefore defined, and optionally a catalyst to said intermediate reaction mixture; and
(iv) polymerising said intermediate reaction mixture to give said composition, wherein catalyst is added in at least step (i) or step (iii).

Viewed from a further aspect, the present invention provides a composition obtainable by or obtained by the method as hereinbefore described.

Viewed from a further aspect, the present invention provides a method of making a moulded article comprising a composition as hereinbefore described, comprising:
(i) heating the composition to a temperature above the Tᵥ of the siloxane-based liquid crystalline elastomer;
(ii) moulding the composition into a desired shape whilst applying a constant tensile stress to give a moulded composition having alignment (e.g. having a required pattern of alignment); and
(iii) cooling the moulded composition to room temperature to give said moulded article.

Viewed from a further aspect, the present invention provides a method of making a moulded article comprising a composition as hereinbefore described, comprising:
(i) heating the composition to a temperature above the Tᵥ of the siloxane-based liquid crystalline elastomer;
(ii) moulding the composition into a desired shape whilst applying a constant tensile and/or shear stress to give a moulded composition having alignment (e.g. having a required pattern of alignment); and
(iii) cooling the moulded composition to room temperature to give said moulded article.

Viewed from a further aspect, the present invention provides a moulded article obtainable by or obtained by the method as hereinbefore described.

Viewed from a further aspect, the present invention provides a moulded article comprising a composition as hereinbefore described.

Viewed from a further aspect, the present invention provides the use of a moulded article as hereinbefore described as an actuator.

### Definitions

As used herein, the term “liquid crystal elastomer” (LCE) refers to a network composed of crosslinked polymer chains that are also liquid crystalline.

As used herein, the term “exchangeable liquid crystal elastomer” (xLCE) refers to a dynamically crosslinked network composed of polymer chains that are also liquid crystalline.

As used herein, the term “siloxane-based liquid crystal elastomer” refers to an exchangeable liquid crystalline elastomer that contains exchangeable siloxane linkages (i.e. —Si—O—Si-linkages). Siloxane-based liquid crystal elastomers described herein are examples of exchangeable liquid crystal elastomers.

As used herein, the term “alkyl” refers to a straight chain (i.e. unbranched) or branched hydrocarbon chain containing 1 to 12 carbon atoms that is completely saturated.

As used herein, the term “heteroalkyl” refers to an alkyl group having one or more heteroatoms (e.g. O, N, or S etc.) in the chain.

As used herein, the term “alkenyl” refers to a straight chain (i.e. unbranched) or branched hydrocarbon chain containing 2 to 12 carbon atoms and having one or more carbon-carbon double bonds.

As used herein, the term “alkynyl” refers to a straight chain (i.e. unbranched) or branched hydrocarbon chain containing 2 to 12 carbon atoms and having one or more carbon-carbon triple bonds.

As used herein, the term “aryl” refers to an aromatic carbocyclic group. It may comprise one or more rings. When more than one ring is present, the rings may independently be fused, and/or bridged.

As used herein, the term “heteroaryl” refers to an aromatic carbocyclic group having one or more heteroatoms (e.g. O, N, or S etc.) in at least one of the rings.

As used herein, the term “cycloalkyl” refers to a saturated cyclic hydrocarbon group containing from 3 to 12 carbon atoms. It may comprise one or more rings. When more than one ring is present, the rings may independently be fused, and/or bridged.

As used herein, the term “heterocycloalkyl” refers to a monocyclic, bicyclic or tricyclic cycloalkyl containing at last one heteroatom in a ring. The term includes rings wherein one or more of the ring carbon atoms is a carbonyl carbon.

As used herein, the term “heterocycle” refers to a monocyclic, bicyclic or tricyclic structure containing at least one heteroatom in a ring.

As used herein the term “substituted” refers to a group wherein one or more, for example up to 6, more especially 1, 2, 3, 4, 5 or 6, of the hydrogen atoms in the group are replaced independently of each other by the corresponding number of the described substituents. The term “optionally substituted” as used herein means substituted or unsubstituted.

As used herein, the term “halogen” refers to one or more of fluoro, chloro, bromo, and iodo.

As used herein, the term “failure strain” refers to a measure of how much a material is elongated prior to failure.

As used herein the term wt % is based on the total mass of the monomers (A1), (B1) and (C1) present in the reaction mixture, unless otherwise specified.

As used herein the term “XX % crosslinked” refers to the crosslinking density of the LCE network. More specifically, the material compositions of the LCE networks described in the examples of this application are characterized by the mol fraction of reacting bonds, thiol-acrylate and thiol-vinyl, always taking the content of mesogenic di-acrylate monomer as 100% (or 1 molar ratio). For example, a “20% crosslinked” network has 20% (or 0.2 molar ratio) of vinyl bonds on 4-functional ring-siloxane crosslinks, and accordingly, the stoichiometric amount of 120% (or 1.2 molar ratio) of dithiol. Similarly, a “100% crosslinked” network has 100% vinyl bonds (1:1 with diacrylate bonds of the mesogens) and accordingly 200% (or 2 molar ratio) of dithiol. As such, according to this nomenclature, the “100% crosslinked” network has exactly two mesogens per crosslink, i.e. on average network strands contain just one mesogen rod between two thiols. In the same way, the “20% crosslinked” network has its strands, on average, with 5 mesogen rods separated by thiol spacers.

As used herein, the term “T_{c}” refers to the liquid crystalline transition temperature to a nematic or smectic phase from the isotropic phase.

As used herein, the term “Tᵥ” refers to the vitrification temperature.

As used herein, the term “T_{g}” refers to the glass transition temperature.

As used herein, the term “actuator” refers to a device that converts a specific stimulus into mechanical work.

As used herein, the term “thermal actuator” refers to an actuator that reversibly changes shape in response to changes in temperature.

As used herein, the term “photo-actuator” refers to an actuator that reversibly changes shape in response to changes in light.

### DETAILED DESCRIPTION OF THE INVENTION

The present invention relates to a siloxane-based liquid crystalline elastomer, preferably an exchangeable siloxane-based liquid crystalline elastomer, derived from monomers (A1), (B1) and (C1), wherein (C1) is an acyclic or cyclic vinyl siloxane, and (A1) and (B1) have the following formulae:

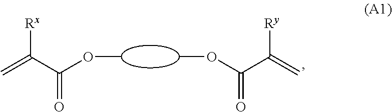

wherein [symbol] is a mesogen, and
R^{x} and R^{y} are independently selected from hydrogen or substituted or unsubstituted C₁₋₁₂ alkyl;

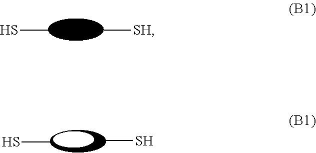

wherein [symbol] is an organic group.

In preferred siloxane-based liquid crystalline elastomers of the present invention, the gap between T_{c} and Tᵥ is in the range 100 to 350° C., preferably 100 to 300° C., more preferably 100 to 250° C., even more preferably 100 to 200° C. (e.g. 150° C.). Without wishing to be bound by theory, the large T_{c}−Tᵥ gap means that it is possible to mould (or program) the siloxane-based liquid crystalline elastomers at high temperature under high stress (i.e. at temperatures above Tᵥ) but to then independently exploit the liquid crystalline transition of the material (e.g. by using the moulded article as an actuator upon heating and cooling around T_{c}). In other words, the two processes do not impact upon each other because the temperatures required for each are so distinct.

Preferred siloxane-based liquid crystalline elastomers of the present invention have a T_{c} in the range 30 to 150° C., preferably 30 to 125° C., more preferably 30 to 100° C., even more preferably 30 to 70° C. (e.g. 60° C.).

Preferred siloxane-based liquid crystalline elastomers of the present invention have a Tᵥ in the range 150 to 300° C., preferably 150 to 280° C., more preferably 150 to 260° C., even more preferably 150 to 250° C. (e.g. 200° C.).

Preferred siloxane-based liquid crystalline elastomers of the present invention have a T_{g} in the range −100 to 0° C., preferably −75 to −10° C., more preferably −50 to −15° C., even more preferably −30 to −20° C. (e.g. −25° C.).

In preferred siloxane-based liquid crystalline elastomers of the present invention, monomer (C1) has a formula selected from (C1a) or (C1b):

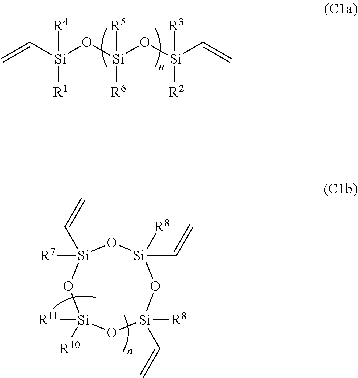

wherein
n is 0 or an integer from 1 to 20; and
each R¹, R², R³, R⁴, R⁵, R⁶, R⁷, R⁸, R⁹, R¹⁰ and R¹¹ are organic groups which may be the same or different.

In preferred siloxane-based liquid crystalline elastomers of the present invention, in monomer (C1) n is 0 or an integer from 1 to 10. In further preferred siloxane-based liquid crystalline elastomers of the present invention, in monomer (C1) n is 0 or an integer from 1 to 5. In further preferred siloxane-based liquid crystalline elastomers of the present invention, in monomer (C1) n is 0 or an integer from 1 to 2.

In preferred siloxane-based liquid crystalline elastomers of the present invention, in monomer (C1) each R¹, R², R³, R⁴, R⁵, R⁶, R⁷, R⁸, R⁹, R¹⁰ and R¹¹ are independently selected from substituted or unsubstituted C₁₋₁₂ alkyl, substituted or unsubstituted heteroalkyl, substituted or unsubstituted C₂₋₁₂ alkenyl, substituted or unsubstituted C₂₋₁₂ alkynyl, substituted or unsubstituted C₃₋₁₂ cycloalkyl, substituted or unsubstituted heterocycloalkyl, substituted or unsubstituted C₅₋₁₈ aryl, and substituted or unsubstituted heteroaryl. Preferably, in monomer (C1) each R¹, R², R³, R⁴, R⁵, R⁶, R⁷, R⁸, R⁹, R¹⁰ and R¹ are independently selected from substituted or unsubstituted C₁₋₁₂ alkyl, substituted or unsubstituted C₂₋₁₂ alkenyl, substituted or unsubstituted heteroalkyl, substituted or unsubstituted C₃₋₁₂ cycloalkyl, and substituted or unsubstituted C₅₋₁₈ aryl. More preferably, in monomer (C1) each R¹, R², R³, R⁴, R⁵, R⁶, R⁷, R⁸, R⁹, R¹⁰ and R¹¹ are independently selected from substituted or unsubstituted C₁₋₆ alkyl, substituted or unsubstituted C₂₋₆ alkenyl and substituted or unsubstituted C₅₋₁₂ aryl. Even more preferably, in monomer (C1) each R¹, R², R³, R⁴, R⁵, R⁶, R⁷, R⁸, R⁹, R¹⁰ and R¹¹ are independently selected from substituted or unsubstituted C₁₋₄ alkyl or substituted or unsubstituted C₂₋₄ alkenyl.

In preferred siloxane-based liquid crystalline elastomers of the present invention, monomer (C1) has a formula (C1b):

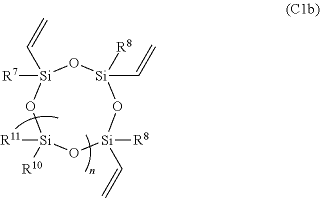

wherein R⁷, R⁸, R⁹, R¹⁰, R¹¹ and n are as hereinbefore defined. The cyclic nature of the monomer (C1) having a formula (C1b) means that the degree of crosslinking can be increased, thereby allowing the properties of the siloxane-based liquid crystalline elastomers to be controlled (see Examples section).

In preferred siloxane-based liquid crystalline elastomers of the present invention, monomer (C1) is selected from:

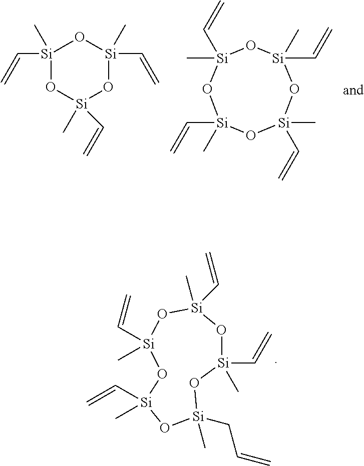

In preferred siloxane-based liquid crystalline elastomers of the present invention, monomer (C1) is:

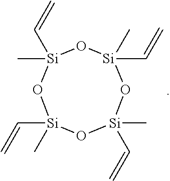 [SMILES: C=C[Si]1(C)O[Si](C)(C=C)O[Si](C)(C=C)O[Si](C)(C=C)O1]

In preferred siloxane-based liquid crystalline elastomers of the present invention, monomer (C1) has a formula (C1a):

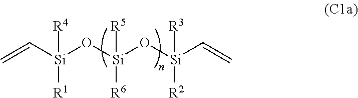

wherein R¹, R², R³, R⁴, R⁵, R⁶ and n are as hereinbefore defined.

In preferred siloxane-based liquid crystalline elastomers of the present invention, monomer (C1) is

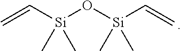

In preferred siloxane-based liquid crystalline elastomers of the present invention, in monomer (B1) [symbol] is an aliphatic or aromatic organic group, said organic group optionally containing at least one heteroatom.

In preferred siloxane-based liquid crystalline elastomers of the present invention, in monomer (B1) [symbol] is selected from substituted or unsubstituted C₁₋₁₂ alkyl, substituted or unsubstituted heteroalkyl, substituted or unsubstituted C₂₋₁₂ alkenyl, substituted or unsubstituted C₂₋₁₂ alkynyl, substituted or unsubstituted C₃₋₁₂ cycloalkyl, substituted or unsubstituted heterocycloalkyl, substituted or unsubstituted C₅₋₁₈ aryl, substituted or unsubstituted heteroaryl, stilbenyl, —(Si(X₁)(X₂)—O)ᵥSi—, —(CH₂)_{q}—(Si(X₁)(X₂)—O)ᵥSi—(CH₂)_{q}—, —(CH₂)_{q}-cycloalkyl-(CH₂)_{q}—, —(CH₂)_{q}-heterocycloalkyl-(CH₂)_{q}—, —(CH₂)_{q}-aryl-(CH₂)_{q}—, —(CH₂)_{q}-heteroaryl-(CH₂)_{q}—, where q and v are integers from 1 to 10 and where the (CH₂)_{q} groups are independently optionally substituted, and where X₁ and X₂ are independent organic groups, preferably C₁₋₁₂ alkyl. Preferably, in monomer (B1) [symbol] is selected from substituted or unsubstituted C₁₋₁₂ alkyl, substituted or unsubstituted heteroalkyl, substituted or unsubstituted C₂₋₁₂ alkenyl, substituted or unsubstituted C₂₋₁₂ alkynyl, substituted or unsubstituted C₃₋₁₂ cycloalkyl, substituted or unsubstituted heterocycloalkyl, —(Si(X₁)(X₂)—O)ᵥ—Si—, —(CH₂)_{q}—(Si(X₁)(X₂)—O)ᵥSi—(CH₂)_{q}—, —(CH₂)_{q}-cycloalkyl-(CH₂)_{q}—, and —(CH₂)_{q}-heterocycloalkyl-(CH₂)_{q}—. More preferably, in monomer (B1) [symbol] is selected from substituted or unsubstituted C₁₋₁₂ alkyl, substituted or unsubstituted heteroalkyl, substituted or unsubstituted C₂₋₁₂ alkenyl, substituted or unsubstituted C₂₋₁₂ alkynyl, substituted or unsubstituted C₃₋₁₂ cycloalkyl, —(Si(X₁)(X₂)—O)ᵥ—Si—, —(CH₂)_{q}—(Si(X₁)(X₂)—O)ᵥSi—(CH₂)_{q}—, and —(CH₂)_{q}-cycloalkyl-(CH₂)_{q}—. Even more preferably, in monomer (B1) [symbol] [symbol] is selected from substituted or unsubstituted C₁₋₁₂ alkyl, substituted or unsubstituted heteroalkyl, substituted or unsubstituted C₃₋₁₂ cycloalkyl, —(Si(X₁)(X₂)—O)ᵥ—Si—, —(CH₂)_{q}—(Si(X₁)(X₂)—O)ᵥSi—(CH₂)_{q}—, and —(CH₂)_{q}-cycloalkyl-(CH₂)_{q}—. Even more preferably, in monomer (B1) [symbol] is selected from substituted or unsubstituted C₁₋₈ alkyl and substituted or unsubstituted heteroalkyl.

In preferred siloxane-based liquid crystalline elastomers of the present invention, monomer (B1) is HS—(CH₂)₂—O—(CH₂)₂—O—(CH₂)₂—SH.

In preferred siloxane-based liquid crystalline elastomers of the present invention, in monomer (A1) R^{x} and R^{y} are independently selected from hydrogen or substituted or unsubstituted C₁₋₆ alkyl. Preferably, R^{x} and R^{y} are independently selected from hydrogen or substituted or unsubstituted C₁₋₃ alkyl. More preferably, R^{x} and R^{y} are each hydrogen.

In preferred siloxane-based liquid crystalline elastomers of the present invention, [symbol] in monomer (A1) is nematic or smectic, preferably nematic.

In preferred siloxane-based liquid crystalline elastomers of the present invention, in monomer (A1) [symbol] has the following formula:

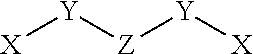

wherein
each X is independently a —(CH₂)ₚ-spacer group which can be substituted or unsubstituted, wherein p is an integer from 1 to 10;
each Y is a linker group independently selected from —O— or —O(CO)O—; and
Z is a mesogenic subgroup.

In preferred siloxane-based liquid crystalline elastomers of the present invention, in monomer (A1) each X is independently a —(CH₂)ₚ-spacer group which can be substituted or unsubstituted, wherein p is an integer from 3 to 8.

In preferred siloxane-based liquid crystalline elastomers of the present invention, in monomer (A1) Z is a mesogenic subgroup comprising a formula selected from

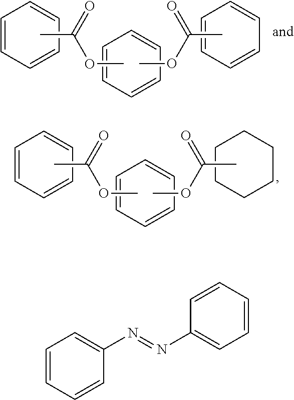

wherein the benzene and/or cyclohexane rings are independently optionally substituted (e.g. with a C₁₋₆ alkyl group).

In preferred siloxane-based liquid crystalline elastomers of the present invention, in monomer (A1) Z is a mesogenic subgroup comprising a formula selected from

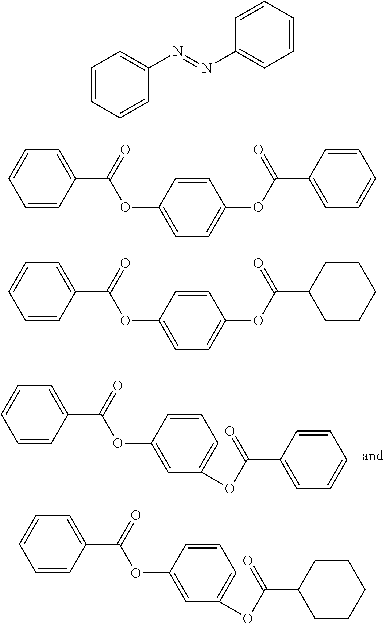

wherein the benzene and/or cyclohexane rings are independently optionally substituted (e.g. with a C₁₋₆ alkyl group).

In preferred siloxane-based liquid crystalline elastomers of the present invention, in monomer (A1) Z is a mesogenic subgroup comprising a formula selected from

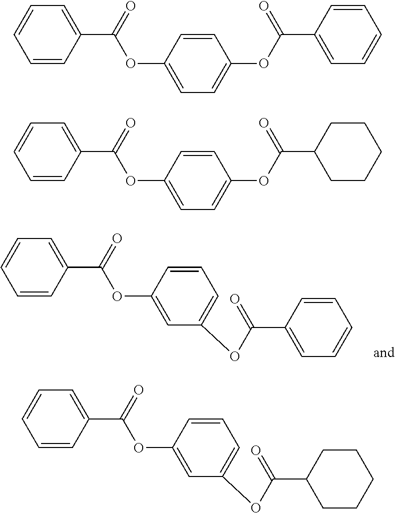 [SMILES: O=C(Oc1ccc(OC(=O)c2ccccc2)cc1)c1ccccc1 ; O=C(Oc1ccc(OC(=O)C2CCCCC2)cc1)c1ccccc1 ; O=C(Oc1cccc(OC(=O)c2ccccc2)c1)c1ccccc1 ; O=C(Oc1cccc(OC(=O)C2CCCCC2)c1)c1ccccc1]

wherein the benzene and/or cyclohexane rings are independently optionally substituted (e.g. with a C₁₋₆ alkyl group). Preferably, the central benzene ring of the mesogenic subgroup is substituted with a C₁₋₄ alkyl group, preferably a methyl group.

In preferred siloxane-based liquid crystalline elastomers of the present invention, monomer (A1) is selected from:

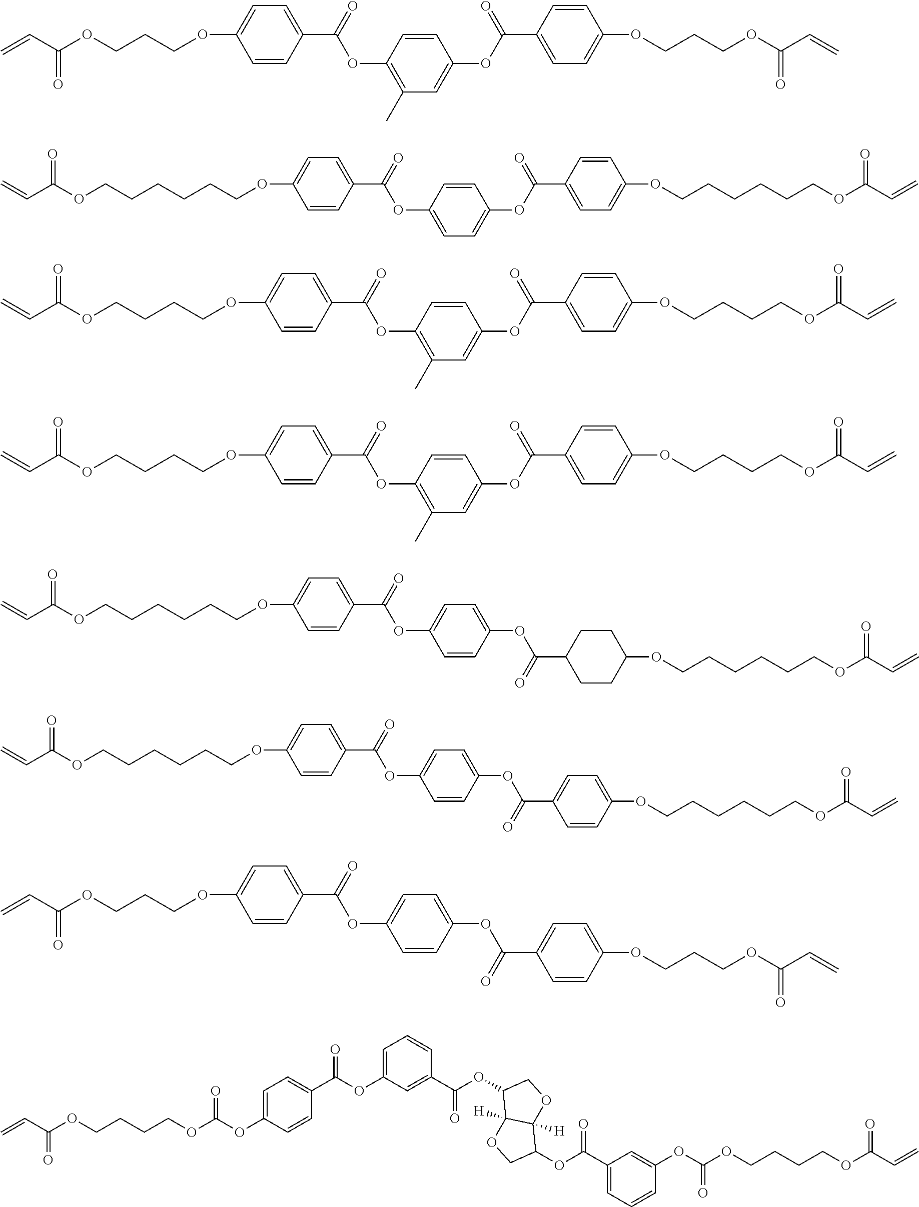

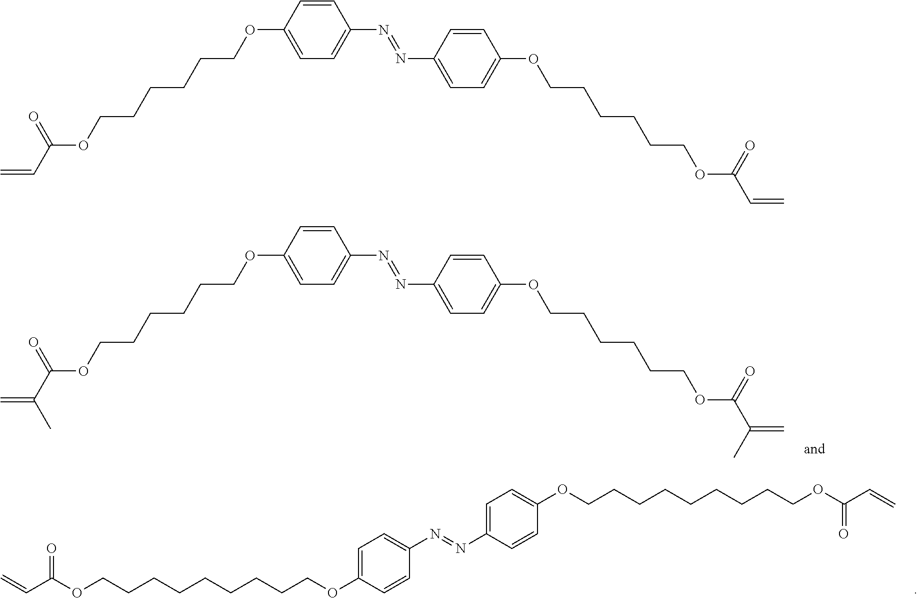

More preferably, monomer (A1) is selected from:

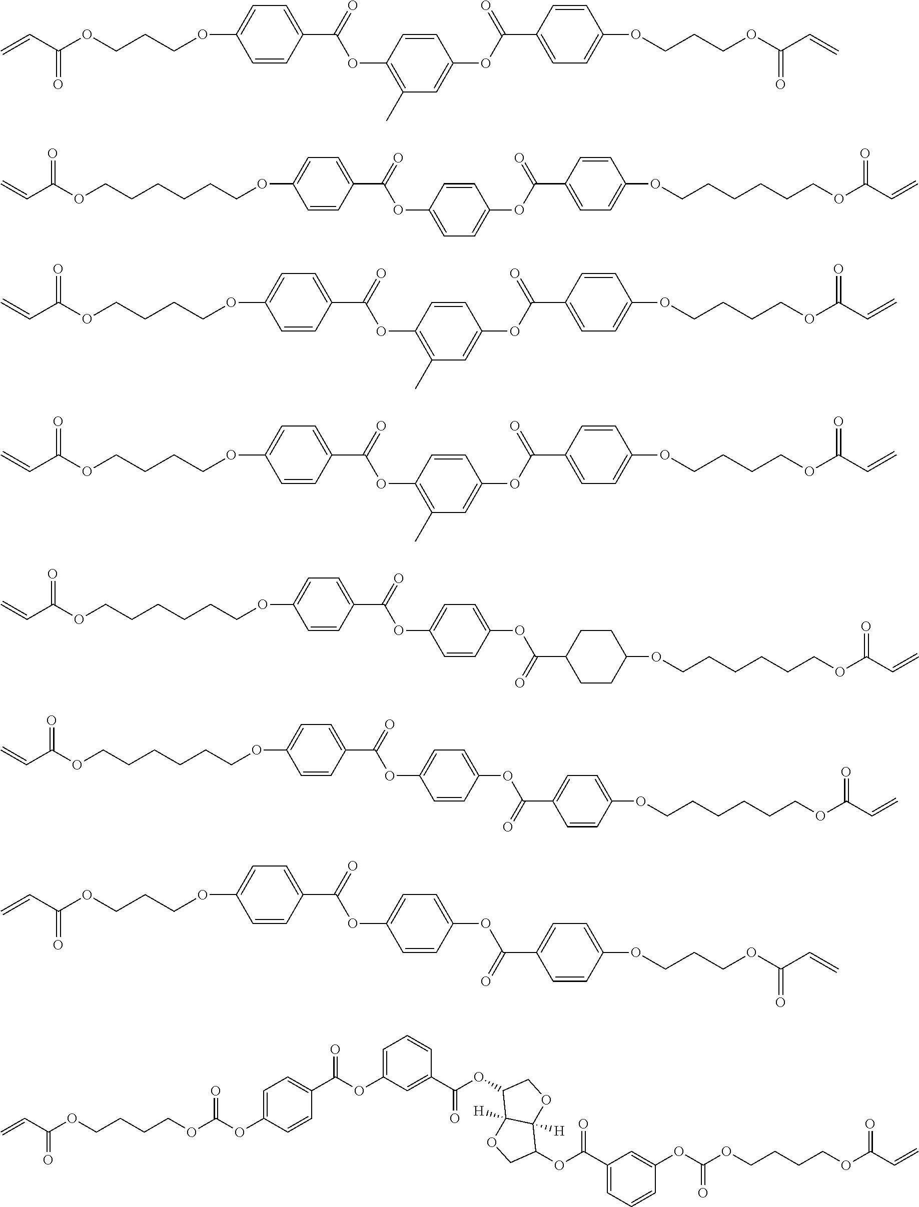

Even more preferably, monomer (A1) is:

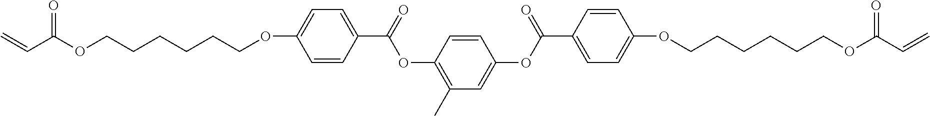 [SMILES: C=CC(=O)OCCCCCCOc1ccc(C(=O)Oc2ccc(OC(=O)c3ccc(OCCCCCCOC(=O)C=C)cc3)c(C)c2)cc1]

Preferred siloxane-based liquid crystalline elastomers of the present invention comprise repeat units of formulae (A), (B), and (Ca) or (Cb):

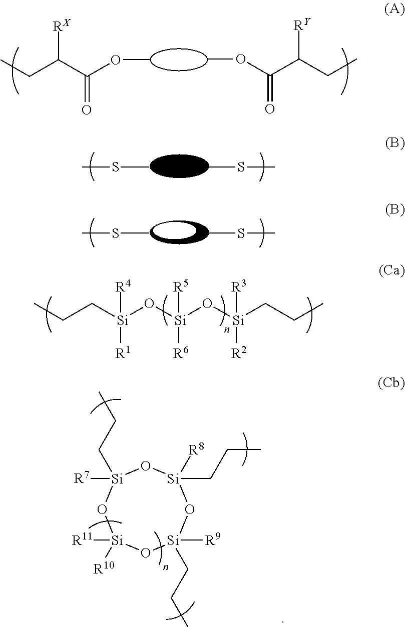

In preferred siloxane-based liquid crystalline elastomers of the present invention, the substituted C₁₋₁₂ alkyl, substituted C₂₋₁₂ alkenyl, substituted C₂₋₁₂ alkynyl, substituted heteroalkyl, substituted C₃₋₁₂ cycloalkyl, substituted heterocycloalkyl, substituted C₅₋₁₈ aryl groups, and substituted heteroaryl groups are independently substituted with C₁-C₁₂ alkyl; OX₃ or —OC(═O)X₃ where X₃ is selected from hydrogen, C₁-C₁₂ alkyl, C₂-C₁₂ alkenyl, C₃-C₁₂ alkynyl, C₃-C₁₂ cycloalkyl, heterocycloalkyl, aryl, and heteroaryl; —C(═O)Rₐ; —C(═O)ORₐ; —NR′R″; halogen; C₂-C₁₂ alkenyl; C₃-C₁₂ cycloalkyl; heterocycloalkyl; C₅₋₁₈ aryl; and heteroaryl; wherein Rₐ, R′ and R″ are independently selected from hydrogen, C₁-C₁₂ alkyl, C₂-C₁₂ alkenyl, C₂-C₁₂ alkynyl, C₃-C₁₂ cycloalkyl, heterocycloalkyl, aryl, and heteroaryl or, together with the nitrogen atom to which they are attached, R′ and R″ form a heterocycle.

In preferred siloxane-based liquid crystalline elastomers of the present invention, the actuation stroke after the fifth heating/cooling cycle is within +/−5% of the actuation stroke after the first heating/cooling cycle. Preferably, the actuation stroke after the fifth heating/cooling cycle is within +/−3% of the actuation stroke after the first heating/cooling cycle. More preferably, the actuation stroke after the fifth heating/cooling cycle is within +/−1% of the actuation stroke after the first heating/cooling cycle. The siloxane-based liquid crystalline elastomers of the present invention therefore demonstrate a remarkable stability in their spontaneous contraction-expansion, meaning that they have the potential to be used as reliable and long-life actuators.

Preferred siloxane-based liquid crystalline elastomers of the present invention have a failure strain of 100 to 500%, preferably 150 to 450%, more preferably 200 to 400% (e.g. 300%). The high failure strain of the siloxane-based liquid crystalline elastomers indicates that they can tolerate significant moulding without breaking or failing (e.g. cracking).

Preferred siloxane-based liquid crystalline elastomers of the present invention further comprise a catalyst.

In preferred siloxane-based liquid crystalline elastomers of the present invention, the catalyst is a base. Suitable bases for use in the siloxane-based liquid crystalline elastomers of the present invention are mild and have high thermal stability.

Preferably, the base is an inorganic base or an organic base.

In preferred siloxane-based liquid crystalline elastomers of the present invention, the inorganic base is an alkali metal hydroxide or an alkali earth metal hydroxide. More preferably, the inorganic base is selected from NaOH, KOH, and Ca(OH)₂.

In preferred siloxane-based liquid crystalline elastomers of the present invention, the organic base is an organic amine, an organic ammonium salt, an organic carboxylate salt, an organic phosphine, or a guanidine-based base. Preferably, the organic base is an organic amine, an organic ammonium salt or an organic carboxylate salt.

Preferably, the organic base is an organic amine. More preferably, the organic amine is a compound having a formula selected from R—NH₂, R₂NH, and R₃N, wherein R is an alkyl group or an aromatic group. Even more preferably, the organic amine is a compound having the formula R₃N. Especially preferably, the organic amine is Et₃N.

Preferably, the organic base is an organic ammonium salt. More preferably, the organic ammonium salt is tetramethylammonium siloxanolate (TMA-Si).

Preferably, the organic base is an organic carboxylate salt. More preferably, the organic carboxylate salt is sodium octanoate.

Preferably, the organic base is an organic phosphine. More preferably, the organic phosphine is triphenylphosphine.

Preferably, the organic base is a guanidine-based base. More preferably, the guanidine-based base is triazobicyclodecene.

In preferred siloxane-based liquid crystalline elastomers of the present invention, the catalyst is an acid. Preferably, the acid is an inorganic acid.

In preferred siloxane-based liquid crystalline elastomers of the present invention, the catalyst is an inorganic acid selected from sulphuric acid, hydrochloric acid, and nitric acid. More preferably, the inorganic acid is sulphuric acid.

The present invention also relates to a composition comprising a siloxane-based liquid crystalline elastomer, preferably an exchangeable siloxane-based liquid crystalline elastomer, as hereinbefore described and a catalyst.

In preferred compositions of the present invention, the catalyst is a base. Suitable bases for use in the compositions of the present invention are mild and have high thermal stability.

Preferably, the base is an inorganic base or an organic base.

In preferred compositions of the present invention, the inorganic base is an alkali metal hydroxide or an alkali earth metal hydroxide. More preferably, the inorganic base is selected from NaOH, KOH, and Ca(OH)₂.

In preferred siloxane-based liquid crystalline elastomers of the present invention, the organic base is an organic amine, an organic ammonium salt, an organic carboxylate salt, an organic phosphine, or a guanidine-based base. Preferably, the organic base is an organic amine, an organic ammonium salt or an organic carboxylate salt.

Preferably, the organic base is an organic amine. More preferably, the organic amine is a compound having a formula selected from R—NH₂, R₂NH, and R₃N, wherein R is an alkyl group or an aromatic group. Even more preferably, the organic amine is a compound having the formula R₃N. Especially preferably, the organic amine is Et₃N.

Preferably, the organic base is an organic ammonium salt. More preferably, the organic ammonium salt is tetramethylammonium siloxanolate (TMA-Si).

Preferably, the organic base is an organic carboxylate salt. More preferably, the organic carboxylate salt is sodium octanoate.

Preferably, the organic base is an organic phosphine. More preferably, the organic phosphine is triphenylphosphine.

Preferably, the organic base is a guanidine-based base. More preferably, the guanidine-based base is triazobicyclodecene.

In preferred compositions of the present invention, the catalyst is an acid. Preferably, the acid is an inorganic acid.

In preferred siloxane-based liquid crystalline elastomers of the present invention, the catalyst is an inorganic acid selected from sulphuric acid, hydrochloric acid, and nitric acid. More preferably, the inorganic acid is sulphuric acid.

The present invention also relates to a method of preparing a composition as hereinbefore described, comprising:
(i) preparing a mixture comprising monomers of each of formula (A1), (B1), and (C1), wherein (C1) is an acyclic or cyclic vinyl siloxane, and a catalyst:

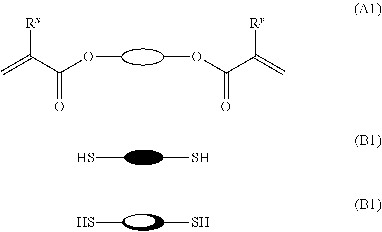

wherein [symbol] R^{x} and R^{y} are as hereinbefore defined;
(ii) polymerising the monomers of formula (A1) and (B1) to give an intermediate reaction mixture comprising a thiol-terminated oligomer, monomers of formula (C1) and a catalyst; and
(iii) photopolymerizing said intermediate reaction mixture to give said composition.

Preferred methods of the present invention are conducted in one pot. The methods of the present invention therefore represent efficient and simple routes to highly complex polymer networks.

In preferred methods of the present invention, the catalyst is present at a loading of 0.1-3.0 wt %, preferably 0.15-2.5 wt %, more preferably 0.2-2.0% wt, even more preferably 0.25-1.5 wt %, even more preferably 0.3-1.0 wt %.

In preferred methods of the present invention, the ratio of the monomers (A1):(B1):(C1) is in the range 1:(1.2 to 2.0):(0.2 to 1.0).

In preferred methods of the present invention, the mixture prepared in step (i) further comprises a photoinitiator. Preferably, the photoinitiator is selected from Igracure 184, Igracure I-500, Igracure 2959, Igracure 754, Igracure I-651, Igracure 369, Igracure 907, Igracure 1300, Igracure 819, Igracure 819DW, Igracure 2022, Igracure 2100, Igracure 784, Igracure 250. More preferably, the photoinitiator is Igracure I-651.

In preferred methods of the present invention, the step (ii) polymerising is for a duration of 1 to 24 h, preferably 6 to 18 h, more preferably 10 to 15 h (e.g. 12 h).

In preferred methods of the present invention, the step (ii) polymerising is at a temperature of 30 to 70° C., preferably 35 to 65° C., more preferably 40 to 60° C. (e.g. 50° C.).

In preferred methods of the present invention, the step (ii) polymerising is for a duration of 1 to 24 h and at a temperature of 30 to 70° C., preferably for a duration of 6 to 18 h and at a temperature of 35 to 65° C., more preferably for a duration of 10 to 15 h and at a temperature of 40 to 60° C. (e.g. 12 h for 50° C.).

In preferred methods of the present invention, the step (iii) photopolymerising is for a duration of 5 to 60 min, preferably 10 to 45 min, more preferably 12 to 30 min (e.g. 15 min).

In preferred methods of the present invention, the step (iii) photopolymerising is at a temperature of 30 to 70° C., preferably 35 to 65° C., more preferably 40 to 60° C. (e.g. 50° C.).

In preferred methods of the present invention, the step (iii) photopolymerising is for a duration of 5 to 60 min and at a temperature of 30 to 70° C., preferably for a duration of 10 to 45 min and at a temperature of 35 to 65° C., more preferably for a duration of 12 to 30 min and at a temperature of 40 to 60° C. (e.g. 15 min for 50° C.).

In preferred methods of the present invention, the step (iii) photopolymerising is at a wavelength of 350 to 400 nm, preferably 360 to 370 nm (e.g. 365 nm).

An example of a method according to the present invention is shown in FIG. 1 (and is demonstrated in the Examples section). In step (i), a mixture of diacrylate liquid crystal monomer, RM82 (monomer (A1)), 2,2′-(ethylenedioxy)diethanethiol, EDDT (monomer (B1)), 2,4,6,8-tetramethyl-2,4,6,8-tetravinyl cyclotetrasiloxane, TMTVCTS (monomer (C1)), and TMA-Si (catalyst) is first prepared. In step (ii), the mixture is subjected to polymerisation conditions to cause the thiol groups of EDDT to react with the acrylate groups of RM82 to give a thiol-terminated oligomer. Catalyst TMA-Si is still present in the intermediate reaction mixture. The intermediate reaction mixture is subjected in step (iii) to a photopolymerisation wherein the thiol groups of the oligomer react with the vinyl groups on TMTVCTS to give a composition comprising a siloxane-based liquid crystalline elastomer as hereinbefore described and a catalyst. This is an example of a one-pot, two step (thiol-acrylate/thiol-ene) reaction.

It is possible to reverse the order of the thiol-acrylate and thiol-ene step, thereby demonstrating the versatility of the method. Thus, the present invention also relates to an alternative method for preparing a composition as hereinbefore described, comprising:
(i) preparing a mixture comprising monomers of each of formula (B1) and (C1), wherein (C1) is an acyclic or cyclic vinyl siloxane, and optionally a catalyst:

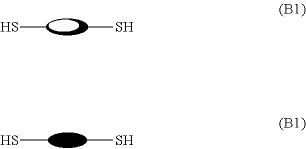

wherein [symbol] is as hereinbefore defined;
(ii) photopolymerizing said mixture to give an intermediate reaction mixture comprising a thiol-terminated siloxane, and optionally a catalyst;
(iii) adding monomers of formula (A1) and optionally a catalyst to said intermediate reaction mixture:

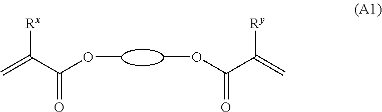

wherein [symbol] R^{x} and R^{y} is as hereinbefore defined; and
(iv) polymerising said intermediate reaction mixture to give said composition,
   wherein catalyst is added in at least step (i) or step (iii).

In preferred methods of the present invention, catalyst is added in step (iii).

In preferred methods of the present invention, at least one composite is added to the intermediate reaction mixture in step (iii). Preferably, the at least one composite is selected from dyes, carbon nanotubes, carbon or other nanoparticles, and liquid metals.

Preferred methods of the present invention are conducted in one pot. The alternative methods of the present invention therefore also represent efficient and simple routes to highly complex polymer networks.

In preferred methods of the present invention, the catalyst is present at a loading of 0.1-3.0 wt %, preferably 0.15-2.5 wt %, more preferably 0.2-2.0% wt, even more preferably 0.25-1.5 wt %, even more preferably 0.3-1.0 wt %.

In preferred methods of the present invention, the ratio of the monomers (A1):(B1):(C1) is in the range 1:(1.2 to 2.0):(0.2 to 1.0).

In preferred methods of the present invention, the mixture prepared in step (i) further comprises a photoinitiator. Preferably, the photoinitiator is selected from Igracure 184, Igracure I-500, Igracure 2959, Igracure 754, Igracure I-651, Igracure 369, Igracure 907, Igracure 1300, Igracure 819, Igracure 819DW, Igracure 2022, Igracure 2100, Igracure 784, Igracure 250. More preferably, the photoinitiator is Igracure I-651.

In preferred methods of the present invention, the step (ii) photopolymerising is for a duration of 5 to 60 min, preferably 10 to 45 min, more preferably 12 to 30 min (e.g. min).

In preferred methods of the present invention, the step (ii) photopolymerising is at a temperature of 30 to 70° C., preferably 35 to 65° C., more preferably 40 to 60° C. (e.g. 50° C.).

In preferred methods of the present invention, the step (ii) photopolymerising is for a duration of 5 to 60 min and at a temperature of 30 to 70° C., preferably for a duration of 10 to 45 min and at a temperature of 35 to 65° C., more preferably for a duration of 12 to 30 min and at a temperature of 40 to 60° C. (e.g. 15 min for 50° C.).

In preferred methods of the present invention, the step (ii) photopolymerising is at a wavelength of 350 to 400 nm, preferably 360 to 370 nm (e.g. 365 nm).

In preferred methods of the present invention, the step (iv) polymerising is for a duration of 1 to 24 h, preferably 6 to 18 h, more preferably 10 to 15 h (e.g. 12 h).

In preferred methods of the present invention, the step (iv) polymerising is at a temperature of 30 to 70° C., preferably 35 to 65° C., more preferably 40 to 60° C. (e.g. 50° C.).

In preferred methods of the present invention, the step (iv) polymerising is for a duration of 1 to 24 h and at a temperature of 30 to 70° C., preferably for a duration of 6 to 18 h and at a temperature of 35 to 65° C., more preferably for a duration of 10 to 15 h and at a temperature of 40 to 60° C. (e.g. 12 h for 50° C.).

The present invention also relates to a composition obtainable by or obtained by a method as hereinbefore described.

The present invention also relates to a siloxane-based liquid crystalline elastomer, preferably an exchangeable siloxane-based liquid crystalline elastomer, derived from monomers (A1), (B1) and (C1), wherein (A1) has a formula selected from

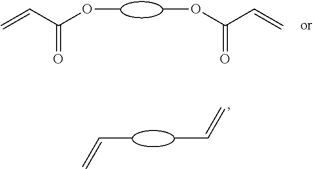

wherein [symbol] is a mesogen;
(B1) has a formula selected from

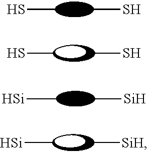

wherein [symbol] is an organic group; and
(C1) is an acyclic or cyclic vinyl siloxane or an acyclic or cyclic thiol siloxane.

Preferred [symbol] and [symbol] are as described above.

Preferred acyclic or cyclic vinyl siloxane (C1) monomers are as described above.

Preferred acyclic or cyclic thiol siloxane (C1) monomers have a formula selected from (C1c) or (C1d):

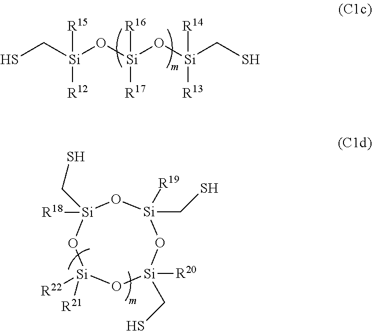

wherein

m is 0 or an integer from 1 to 20; and

each R¹², R¹³, R¹⁴, R¹⁵, R¹⁶, R¹⁷, R¹⁸, R¹⁹, R²⁰, R²¹ and R²² are organic groups which may be the same or different.

In preferred siloxane-based liquid crystalline elastomers of the present invention, in monomer (C1) m is 0 or an integer from 1 to 10. In further preferred siloxane-based liquid crystalline elastomers of the present invention, in monomer (C1) m is 0 or an integer from 1 to 5. In further preferred siloxane-based liquid crystalline elastomers of the present invention, in monomer (C1) m is 0 or an integer from 1 to 2.

In preferred siloxane-based liquid crystalline elastomers of the present invention, in monomer (C1) each R¹², R¹³, R¹⁴, R¹⁵, R¹⁶, R¹⁷, R¹⁸, R¹⁹, R²⁰, R²¹ and R²² are independently selected from substituted or unsubstituted C₁₋₁₂ alkyl, substituted or unsubstituted heteroalkyl, substituted or unsubstituted C₂₋₁₂ alkenyl, substituted or unsubstituted C₂₋₁₂ alkynyl, substituted or unsubstituted C₃₋₁₂ cycloalkyl, substituted or unsubstituted heterocycloalkyl, substituted or unsubstituted C₅₋₁₈ aryl, and substituted or unsubstituted heteroaryl. Preferably, in monomer (C1) R¹², R¹³, R¹⁴, R¹⁵, R¹⁶, R¹⁷, R¹⁸, R¹⁹, R²⁰, R²¹ and R²² are independently selected from substituted or unsubstituted C₁₋₁₂ alkyl, substituted or unsubstituted C₂₋₁₂ alkenyl, substituted or unsubstituted heteroalkyl, substituted or unsubstituted C₃₋₁₂ cycloalkyl, and substituted or unsubstituted C₅₋₁₈ aryl. More preferably, in monomer (C1) each R¹², R¹³, R¹⁴, R¹⁵, R¹⁶, R¹⁷, R¹⁸, R¹⁹, R²⁰, R²¹ and R²² are independently selected from substituted or unsubstituted C₁₋₆ alkyl, substituted or unsubstituted C₂₋₆ alkenyl and substituted or unsubstituted C₅₋₁₂ aryl. Even more preferably, in monomer (C1) each R¹², R¹³, R¹⁴, R¹⁵, R¹⁶, R¹⁷, R¹⁸, R¹⁹, R²⁰, R²¹ and R²² are independently selected from substituted or unsubstituted C₁₋₄ alkyl or substituted or unsubstituted C₂₋₄ alkenyl.

Preferably, monomer (C1) is a cyclic thiol siloxane which has a formula (C1d)

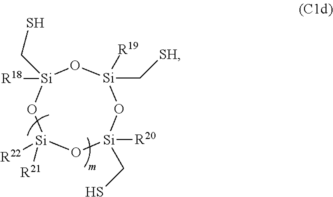

wherein R¹⁸, R¹⁹, R²⁰, R²¹, R²² and m are as hereinbefore defined. The cyclic nature of the monomer (C1) having a formula (C1d) means that the degree of crosslinking can be increased, thereby allowing the properties of the siloxane-based liquid crystalline elastomers to be controlled (see Examples section).

Preferably, monomer (C1) is a cyclic thiol siloxane which is selected from:

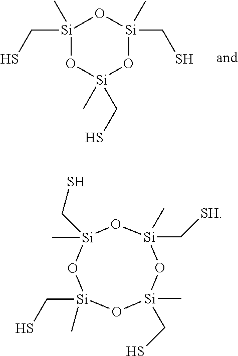 [SMILES: C[Si]1(CS)O[Si](C)(CS)O[Si](C)(CS)O1 ; C[Si]1(CS)O[Si](C)(CS)O[Si](C)(CS)O[Si](C)(CS)O1]

Preferably, monomer (C1) is an acyclic thiol siloxane which has a formula (C1c)

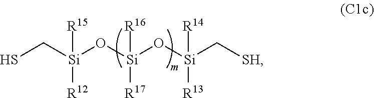

wherein R¹², R¹³, R¹⁴, R¹⁵, R¹⁶, R¹⁷ and m are as hereinbefore defined.

Preferably, monomer (C1) is an acyclic thiol siloxane which is:

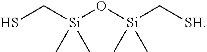

Preferred siloxane-based liquid crystalline elastomers of the present invention, comprise repeat units of formulae (A), (B), and (Ca), (Cb), (Cc) or (Cd):

wherein the repeat unit of formula (A) is

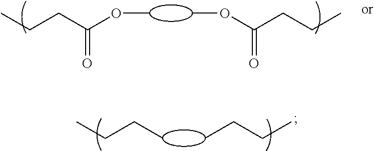

wherein the repeat unit of formula (B) is

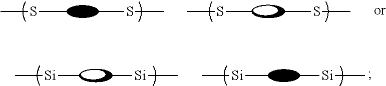

wherein the repeat unit of formula (Ca) is

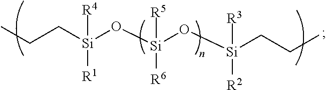

wherein the repeat unit of formula (Cb) is

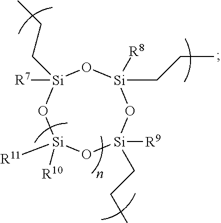

wherein the repeat unit of formula (Cc) is

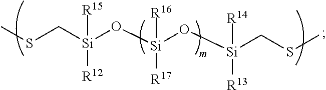

and
wherein the repeat unit of formula (Cd) is

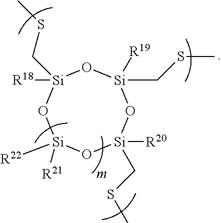

In preferred siloxane-based liquid crystalline elastomers of the present invention, the substituted C₁₋₁₂ alkyl, substituted C₂₋₁₂ alkenyl, substituted C₂₋₁₂ alkynyl, substituted heteroalkyl, substituted C₃₋₁₂ cycloalkyl, substituted heterocycloalkyl, substituted C₅₋₁₃ aryl groups, and substituted heteroaryl groups are independently substituted with C₁-C₁₂ alkyl; OX₃ or —OC(═O)X₃ where X₃ is selected from hydrogen, C₁-C₁₂ alkyl, C₂-C₁₂ alkenyl, C₃-C₁₂ alkynyl, C₃-C₁₂ cycloalkyl, heterocycloalkyl, aryl, and heteroaryl; —C(═O)Rₐ; —C(═O)ORₐ; —NR′R″; halogen; C₂-C₁₂ alkenyl; C₃-C₁₂ cycloalkyl; heterocycloalkyl; C₅₋₁₈ aryl; and heteroaryl; wherein Rₐ, R′ and R″ are independently selected from hydrogen, C₁-C₁₂ alkyl, C₂-C₁₂ alkenyl, C₂-C₁₂ alkynyl, C₃-C₁₂ cycloalkyl, heterocycloalkyl, aryl, and heteroaryl or, together with the nitrogen atom to which they are attached, R′ and R″ form a heterocycle.

Preferably, the siloxane-based liquid crystal elastomer of the present invention further comprises a catalyst. Preferred catalysts are as described above.

Preferred physical features of the siloxane-based liquid crystalline elastomer of the present invention are as described above.

The present invention also relates to a composition comprising a siloxane-based liquid crystalline elastomer, preferably an exchangeable siloxane-based liquid crystalline elastomer, as hereinbefore described, and a catalyst.

Preferred features of the composition of the present invention are as described above.

The present invention also relates to a method of preparing a composition as hereinbefore described, comprising:
(i) preparing a mixture comprising monomers of each of formula (A1), (B1), and (C1) as hereinbefore defined, and a catalyst;
(ii) polymerising the monomers of formula (A1) and (B1) to give an intermediate reaction mixture comprising a thiol-terminated oligomer, an acrylate-terminated oligomer, a vinyl-terminated oligomer, or a silane-terminated oligomer, monomers of formula (C1) and a catalyst; and
(iii) photopolymerizing said intermediate reaction mixture to give said composition.

Preferred features of the method of the present invention are as described above.

The present invention also relates to an alternative method of preparing a composition as hereinbefore described, comprising:
(i) preparing a mixture comprising monomers of each of formula (B1) and (C1), as hereinbefore defined, and optionally a catalyst;
(ii) photopolymerizing said mixture to give an intermediate reaction mixture comprising a thiol-terminated siloxane, a vinyl-terminated oligomer, or a silane-terminated siloxane, and optionally a catalyst;
(iii) adding monomers of formula (A1) as hereinbefore defined, and optionally a catalyst to said intermediate reaction mixture; and
(iv) polymerising said intermediate reaction mixture to give said composition, wherein catalyst is added in at least step (i) or step (iii).

Preferred features of the method of the present invention are as described above.

The present invention also relates to a composition obtainable by or obtained by a method as hereinbefore described.

The present invention also relates to a method of making a moulded article comprising a composition as hereinbefore described, comprising:
(i) heating the composition to a temperature above the Tᵥ of the siloxane-based liquid crystalline elastomer;
(ii) moulding the composition into a desired shape whilst applying a constant tensile stress to give a moulded composition having alignment (e.g. having a required pattern of alignment); and
(iii) cooling the moulded composition to room temperature to give said moulded article.

Thus, unlike the conventional methods for processing LCEs, the method of the present invention involves aligning the material after crosslinking has taken place. This has the advantage of allowing non-permanent (i.e. remouldable) networks to be produced.

In preferred methods of the present invention, the step (ii) moulding is selected from shear extrusion (e.g. 3D printing), uniaxial alignment, surface alignment and injection moulding.

In preferred methods of the present invention, the step (ii) moulding is by shear extrusion, preferably 3D printing.

In preferred methods of the present invention, the step (ii) moulding is by uniaxial alignment.

In preferred methods of the present invention, the step (ii) moulding is by surface alignment.

In preferred methods of the present invention, the step (ii) moulding is by injection moulding.

In preferred methods of the present invention, the step (ii) moulding is monitored by X-ray diffraction, e.g. to determine when alignment (e.g. the required pattern of alignment) is achieved.

In preferred methods of the present invention, the moulded article is a uniaxially aligned monodomain.

In preferred methods of the present invention, the step (ii) moulding involves siloxane bond exchange within the siloxane-based liquid crystalline elastomer. Without wishing to be bound by theory, it is thought that the moulding step, which occurs at high temperature and stress, causes the siloxane crosslinking bonds present in the siloxane liquid crystal elastomers to undergo exchange reactions, which are catalysed by the catalyst (e.g. base) present. The result is that the material is “programmed” to have alignment and this “programming” is permanent, provided the moulded article is not subsequently heated above its Tᵥ. This means that the liquid crystalline properties of the material can be exploited, e.g. by subjecting the moulded article to a heating and cooling cycle at temperatures around the T_{c}, which will cause the moulded article to contract and expand, respectively (see Example 6). The bond-exchange properties of the material can also be exploited: by heating the moulded article back up to temperatures above Tᵥ siloxane exchange will be reinitiated, allowing the article to be moulded into a different shape. The siloxane-based liquid crystalline elastomers of the present invention therefore have important applications in the field of actuation.

The present invention also relates to a moulded article obtainable by or obtained by the method as hereinbefore described.

The present invention also relates to a moulded article comprising a composition as hereinbefore described.

Preferred moulded articles of the present invention are reversibly actuated upon a change in temperature. Preferred moulded articles of the present invention contract upon heating. Preferred moulded articles of the present invention expand upon cooling.

Preferred moulded articles of the present invention can be remoulded, preferably by the method as hereinbefore described.

The present invention also relates to the use of a moulded article as hereinbefore described as an actuator. Preferably, the actuator is a thermal actuator or a photo-actuator.

### BRIEF DESCRIPTION OF THE FIGURES

FIG. 1 shows the reaction scheme for the thiol-acryalte/thiol-ene click chemistry used in the examples of this application.

FIG. 2a shows the general mechanism of siloxane exchange enabled by acid or base catalyst.

FIG. 2b shows two possible routes of siloxane exchange enabled by acid or base catalyst for the xLCEs of the present invention: the siloxanolate catalyst breaks the ring and terminates the linear 4-functional siloxane crosslink (“ring opening”), or two ring-crosslinks join into a single 8-functional ring, which may later exchange into two different 4-crosslinks due to its flexibility (“ring merging”).

FIG. 3 shows differential scanning calorimetry (DSC) of xLCE networks of the present invention on heating. xLCE networks with different crosslinking density were tested and FIG. 3 shows the glass-(T_{g}) and the nematic-isotropic (T_{c}) transition temperature variation with composition.

FIG. 4a shows scaled stress-relaxation σ(t)/σₘₐₓ for the 40%-crosslinked xLCE at T=190° C., and several concentrations of catalyst.

FIG. 4b shows stress relaxation curves for the 40%-crosslinked xLCE at 1 wt % of TMA-Si catalyst, and several temperatures. Dashed lines are the fits with exponential function, which produce the relaxation time τ=1/β.

FIG. 5a shows the Arrhenius plots for the relaxation time τ(T) for different xLCE networks (i.e. the 20%, 40% and 100% crosslinked networks). The slope of the linear fitting gives the bond strength ΔG≈28 kcal/mol, and the additive constant gives the ‘rate of attempts’ ω₀.

FIG. 5b shows a comparison of the scaled stress relaxation at 200° C. for the 20%, 40% and 100% crosslinked networks.

FIG. 6a shows how strain changes with temperature in a sample of the 40%-crosslinked xLCE under constant stress.

FIG. 6b shows the results of programming an aligned monodomain in the 40%-crosslinked xLCE.

FIG. 6c shows how strain changes with temperature in samples of the 40% crosslinked xLCE under constant tensile stress, where the xLCE has been prepared with different types of catalyst.

FIG. 7a shows the initial polydomain 40%-crosslinked xLCE (top) and the uniaxially aligned monodomain 40%-crosslinked xLCE, programmed by its plastic flow to 100% elongation (bottom).

FIG. 7b shows two microscopy images between crossed polars of the uniaxially aligned monodomain 40%-crosslinked xLCE.

FIG. 7c shows an X-ray image of the uniaxially aligned monodomain 40%-crosslinked xLCE.

FIG. 8a shows one cycle of heating-cooling (over the range −50° C. to 90° C.) of the uniaxially aligned monodomain 40%-crosslinked xLCE, demonstrating the classical reversible thermal actuation of LCE.

FIG. 8b shows the cyclic contraction-extension of the uniaxially aligned monodomain 40%-crosslinked xLCE during 11 of the heating cycles shown in FIG. 8a.

FIG. 8c shows the actuation strain plotted against temperature for the uniaxially aligned monodomain 40%-crosslinked xLCE, showing the reproducibility of actuation and also the extent of thermal hysteresis at the applied heating rate of 3°/min.

FIG. 9 shows the appearance of a thermally molded continuous strip, which combines three different xLCE materials: the 20%, 40%, and 100% crosslinked material, at various temperatures.

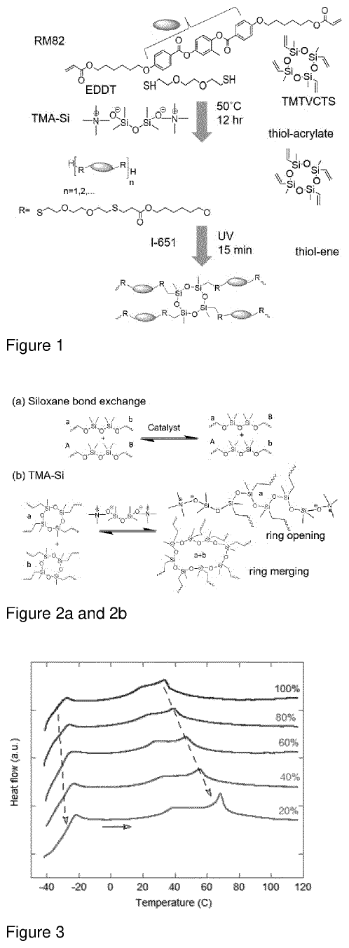

### EXAMPLES

### Materials

Diacrylate liquid crystal (LC) monomer, RM82, was purchased from Wilshire Technologies, Inc.

2,2′-(Ethylenedioxy)diethanethiol (EDDT), 2,4,6,8-tetramethyl-2,4,6,8-tetravinyl cyclotetrasiloxane (TMTVCTS), triethylamine (TEA), Irgacure I-651, toluene, and tetrahydrofuran were purchased from Sigma-Aldrich.

Tetramethylammonium siloxanolate (TMA-Si) was purchased from Gelest.

### Measurement Methods

Differential Scanning Calorimetry (DSC)
DSC4000 PerkinElmer was used to obtain the transition temperatures. Samples with ≈10 mg were loaded into standard aluminum DSC pans. The samples were heated to 120° C. at 10° C. min-1, held isothermally for 5 min to undo the thermal history, and cooled to −50° C. at 10° C. min-1. Then samples were heated again to 120° C. to obtain the data. T_{g} could be found at the step change in the slope of the heat flow signal and T_{c} could be obtained at local minimum of the endothermic peak. The sample was run three times.
Stress Relaxation Measurements
DMAQ800 (TA instruments) was used to characterize the relaxation behavior of siloxane crosslinked LCE. Samples with dimensions of ≈15 mm×5 mm×0.9 mm were tested. All of the samples were tested under constant uniaxial strain 3% imposed at t=0, the strain was held constant isothermally for 180 min at 170, 180, 190, 200, or 210° C. Prior to imposing the strain, samples were kept at the desired temperature for 5 min. Samples were annealed at 80° C. for 12 h before the relaxation test.
Iso-Force Measurements
DMAQ800 (TA instruments) was used to characterize the plastic flow of siloxane crosslinked LCE induced by siloxane bond exchange as a function of temperature. Samples with dimensions of ≈15 mm×5 mm×0.9 mm were tested. All of the samples were tested under constant uniaxial stress of 14, 35, 65, 96, 0r 146 kPa imposed at t=0, the stress was held constant while the temperature was ramped at 2° C./min until 260° C. Prior to imposing the stress, samples were kept at the desired temperature for 5 min. Samples were annealed at 80° C. for 12 h before the relaxation test.
Programing Monodomain Measurements
DMAQ800 (TA instruments) was used to align polydomain samples into monodomain via creep test. Samples with dimensions of ≈15 mm×5 mm×0.9 mm were tested. All samples were tested under constant uniaxial stress of 50, 100, 150, or 200 kPa imposed at t=0, the stress was held constant isothermally at 250° C. until the strain reached 100%. Prior imposing the stress, samples were kept at the desired temperature for 2 min. After reaching 100% strain the samples were kept starched while cooling to room temperature. Samples were annealed at 80° C. for 12 h before the relaxation test.
Wide Angle x-Ray Scattering (WAXS)
The phase of the monodomain LCE at room temperature was characterized using a Philips diffractometer using a Philips Copper target (PW-2233/20) with the wavelength of 0.154 nm. The beam size was ˜0.7×0.7 mm² with flux of 4×10\hat{ }⁹ X-ray/s. The distance between the sample and the imaging area was 100 mm. The sample (0.5 mm×6.5 mm and 20 mm) was exposed to the x-ray source for 20 seconds.
Actuation Measurements
Discovery DMA850 (TA instruments) was used to measure the actuation performance for the monodomain film. Rectangular samples measuring approximately 15 mm×5 mm×0.5 mm were tested in tensile mode. To measure actuation strain, a constant stress (12 kPa) was applied to the LCE film; each sample was heated and cooled at least 11 times from 100 to −50° C., at 3° C. min-1.
Welding Conditions
Moore hydraulic press (Birmingham, England) was used to hot press the LCE samples. Samples were first held at 250° C. for 5 min before applying a load of 0.5 ton. The samples were allowed to cool to room temperature under the applied load.

### LCE Network Preparation Method

LCE networks were prepared using a one pot two-step thiol-acrylate/thiol-ene reaction sequence. First, LC oligomers were prepared via a self-limiting thiol-acrylate Michael addition between a mesogenic diacrylate (RM82) and an isotropic dithiol (EDDT). The Michael addition was catalyzed via TMA-Si or TEA. By controlling the molar ratio of thiol to acrylate, thiol-terminated oligomers were obtained. The di-thiol oligomer was then radically crosslinked with vinyl siloxane crosslinker, TMTVCTS. Reaction progress was monitored by Fourier-transform IR spectroscopy (using a Nicolet 750 Magna FTIR spectrometer with KBr beam splitter and an MCR/A detector) and swelling and gel fraction experiments. The experimental method is outlined below.

In a 25 ml vial the intended amount of catalyst TMA-Si (0.1, 0.3, 1, or 3 wt %), was initially dissolved in a mixture of solvent (20 wt % THF and 20 wt % toluene), and to this solution RM82 was added and heated to 80° C. until fully dissolved. After the mixture was cooled down to room temperature, I-651 (1.5 wt %), EDDT, and TMTVCTS were added and mixed vigorously using a vortex mixer. The solution of monomers was degassed using a vacuum chamber and then quickly transferred into a mold (two glass sides with 1 mm spacer coated with ran-x, an anti-sticking agent). The monomer mixture was kept at 50° C. to fully oligomerize via Michael addition reaction for 12 h. Then the thiol-terminated oligomer was photopolymerized with TMTVCTS via 365 nm UV light for 15 min at 50° C. The ratio of thiol, acrylate, and vinyl molar functional groups was kept constant in all samples. The molar ratio used was 1.0 diacrylate:1.4 dithiol:0.4 vinyl, unless otherwise noted. After the polymerization was compete, the samples were removed from the mold and placed in a vacuum oven at 80° C. for 12 h to remove the solvents.

LCE networks having different crosslinking densities were also be prepared using the above method, but by varying the molar ratio of the reactants. As outlined in Table 1 below, the material compositions of the LCE networks prepared were characterized by the mol fraction of reacting bonds, thiol-acrylate and thiol-vinyl, always taking the content of mesogenic di-acrylate RM82 monomer as 100% (or 1 molar ratio). As such, the lowest crosslinking density network prepared, labelled as “20% crosslinked”, has 20% (or 0.2 molar ratio) of vinyl bonds on 4-functional ring-siloxane crosslinks, and accordingly, the stoichiometric amount of 120% (or 1.2 molar ratio) of thiols on the di-functional chain extender EDDT (see Table 1). At the opposite end, the highest crosslinked network prepared, labelled as “100% crosslinked”, has 100% vinyl bonds (1:1 with acrylate bonds of the mesogens), and accordingly 200% (or 2 molar ratio) of thiols. For instance, according to this nomenclature, the “100% crosslinked” network has exactly two RM82 mesogens per crosslink, that is, on average network strands contain just one RM82 rod between two thiols. In the same way, the “20% network” has its strands, on average, with 5 RM82 rods separated by thiol spacers.

TABLE 1

| Network | Mass of | Mass of | Mass of |
|---|---|---|---|
| description | RM82 | EDDT | TMTVCTS |
| 20% crosslinked | 1 | 0.3341 | 0.0511 |
| (20% TMTVCTS) | | | |
| 40% crosslinked | 1 | 0.3898 | 0.1023 |
| (40% TMTVCTS) | | | |
| 60% crosslinked | 1 | 0.4454 | 0.1534 |
| (60% TMTVCTS) | | | |
| 80% crosslinked | 1 | 0.5011 | 0.2045 |
| (80% TMTVCTS) | | | |
| 100% crosslinked | 1 | 0.5568 | 0.2557 |
| (100% TMTVCTS) | | | |

### Example 1

The DSC results of the series of materials outlined above is shown in FIG. 3 (i.e. the 20%, 40%, 60%, 80% and 100% crosslinked materials). The glass transition (T_{g}) is around −30° C. with very little change observed even when the crosslinking density is significantly increased. This is thought to be attributed to flexibility of the siloxane crosslinker and reduction of the rigid mesogenic units. On the other hand, it can be seen that the reduction of these mesogenic units reduces the nematic-isotropic transition (T_{c}). It is noted that even the “100% crosslinked” LCE has a broad range of the liquid-crystalline phase below T_{c}˜32° C.

### Example 2

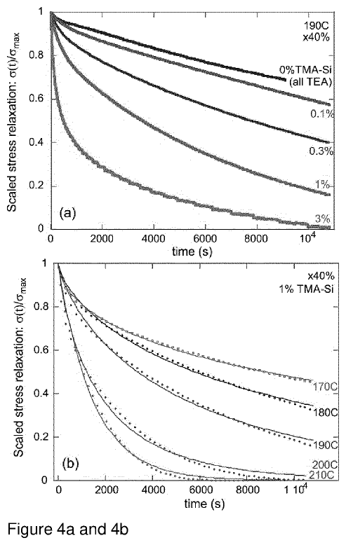

FIG. 4 shows the results of a typical stress-relaxation in the xLCE, which takes place after an instant fixed-strain is imposed on the sample (maintaining the constant temperature). The results are presented via a scaled relaxation function σ(t)/σₘₐₓ, in order to focus purely on the time dependence.

The normalized stress as a function of time for 40% TMTVCTS samples containing various TEA and TMA-Si concentrations is shown in FIG. 4a. In this example, which is conducted at T=190° C., networks with 3 wt % of TMA-Si catalyst, and with a total of 1 wt % of a catalyst mixture of TMA-Si and TEA in ratios 1:0, 0.3:0.7, 0.1:0.9 and 0:1, respectively, are compared. The slowest relaxation is seen in the 1% TEA sample (labelled as 0% TMA-Si in the plot), however, an increasing fraction of TMA-Si makes the bond exchange faster. Both of these amines can trigger the relaxation of the siloxane elastomer, however, TEA is a more volatile catalyst at elevated temperature. Therefore, it has a slower stress relaxation compared to TMA-Si.

The fitting of such scaled stress relaxation curves with the basic exponential relaxation for 1% TMA-Si is shown in FIG. 4b. This exercise provides the characteristic relaxation time τ for each material and temperature. As expected, increasing the temperature accelerated the relaxation, and at 210° C. the elastomer was found to be fully relaxed after 7000 s due to its internal plastic flow.

### Example 3

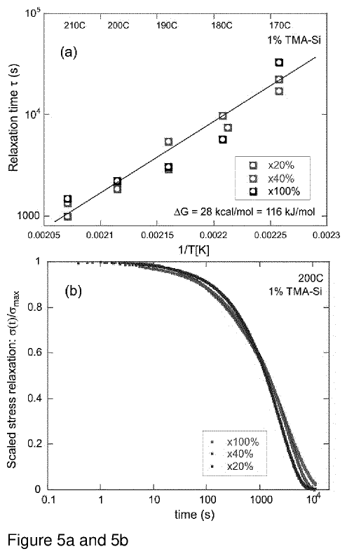

To study the influence of the siloxane concentration on the stress relaxation, siloxane crosslinked networks containing various siloxane concentrations (e.g. 20, 40, and 100 functional mol %) were tested, with each network having the same amount of catalyst (1 wt % of TMA-Si). The relaxation time data for various samples were then collated at different temperatures to generate the Arrhenius plot shown in FIG. 5 (i.e. τ(T) is plotted on the logarithmic scale, and the data is then fitted with the activation law ln[τ]=const+ΔG/k_{B}T).

Referring to FIG. 5a, the data shows a single value of activation energy ΔG≈28 kcal/mol (or 116 kJ/mol), which corresponds to about 45 k_{B}T at room temperature, and is in good agreement with the results of Xie et al. (Adv. Mater. 2019, 31 (11), 1807326) who used 0.1 wt % of sodium octanoate as catalyst in a much higher siloxane concentration elastomer (Sylgard 184 PDMS). In comparison, in the work of Leibler et al. (Science (80-.). 2011, 334 (6058), 965-968), the transesterification with the zinc acetate catalyst had an activation energy ΔG≈20 kcal/mol (or 34 k_{B}T). It is expected that the single value of activation energy ΔG describes the macroscopic stress relaxation: this is a clear signature of the distinct reaction, in this case depicted in FIG. 2b.

Surprisingly, siloxane elastomers with very different concentration of crosslinker appear to have the same ‘rate of attempts’ wo in their relaxation behavior. This was confirmed by comparing the relaxation curves for these different networks at the same temperature (see FIG. 5b). Without wishing to be bound by theory, it is thought that this means the first exchange route depicted in FIG. 2b above (i.e. the ring opening mechanism) is the dominant process or perhaps even the only possible route for the bond exchange. This is because a relatively large amount of catalyst is used in this system (˜1 wt %) and the catalyst helps terminate the rings after their opening. Furthermore, it is thought that the contact of two siloxane-ring crosslinkers in the stretched network has a low probability, while the mobile TMA-Si catalyst can reach any location in the network. As the catalyst content was the same in the data shown in FIG. 5, so are the relaxation rates.

### Example 4

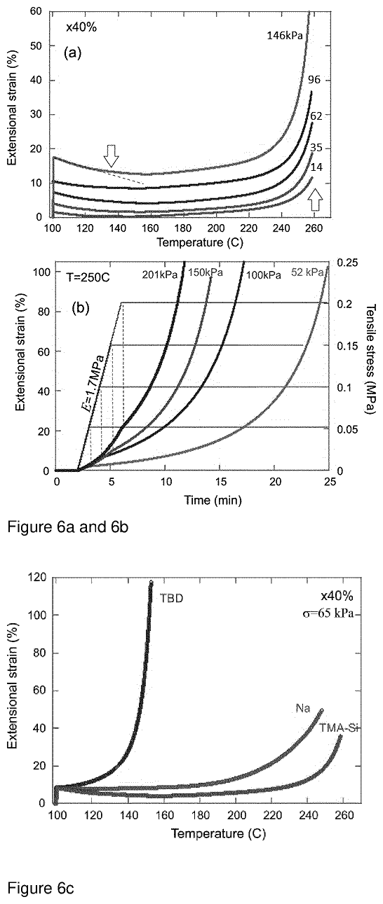

FIG. 6 shows the results of the dynamic response of the 40% crosslinked xLCE prepared as above, due to the siloxane exchange reaction allowing plastic flow under stress, at a sufficiently high temperature. Referring to FIG. 6a, this test shows how the strain changes with temperature in the sample under constant tensile stress (NB: such a test is often incorrectly called “dilatometry” in the literature). In an LCE material, the effect of LCE thermal actuation produces a massive strain change on heating into the isotropic phase. This example is focused on the elastic-plastic transition of the exchangeable network, and so the starting temperature was set at 100° C. (i.e. well in the isotropic phase for the 40% crosslinked xLCE). A given stress (as labelled in FIG. 6a) was applied to the material, and the resulting extensional strain was then registered, which gives the value of the Young modulus of the material (E≈ 880 kPa). The temperature was then increased at a constant rate of 2°/min and the extensional strain monitored.

The results show that the classical rubber-elastic response is initially observed: as the (entropic) rubber modulus increases with temperature, at constant stress the strain decreases. However, as the temperature increases further, and the bond-exchange becomes more prominent, the plastic flow (creep) starts being noticeable. The region where the data deviates from the initial rubber-elastic decreasing slope is identified as the transition to plastic flow, the vitrification point Tᵥ: apparently it does not depend on the applied stress. Some creep under stress in a network with siloxane-exchange above 140-150° C. is to be expected, although the rapid flow only sets in at a much higher temperature (over 250° C.).

FIG. 6c shows how the strain changes with temperature in the 40% crosslinked xLCE sample under constant tensile stress where the xLCE has been prepared with different types of catalyst (either 1 wt % 1,5,7-triazabicyclo[4.4.0]dec-5-ene (TBD), 1 wt % sodium octanoate (Na⁺), or 1 wt % TMA-Si). The results show that the choice of base can influence the temperature at which rapid flow sets in, and therefore also the temperature gap between T_{c} and Tᵥ.

### Example 5

The regime of stress-induced plastic flow demonstrated in Example 4 can be used to program the xLCE materials into a monodomain aligned state. Referring to FIG. 6b, the sample of 40% crosslinked xLCE prepared as above is brought to a high temperature (T=250° C.) as suggested by the results of iso-stress test of Example 4. A constant tensile stress is then applied to a level labelled in FIG. 6b, and the sample is kept at this constant temperature and stress until its elongation reaches 100%. As can be clearly seen, this process happens faster at higher stress, but in all cases takes several minutes and allows easy control. The programmed sample is then removed from the stress and heating conditions.

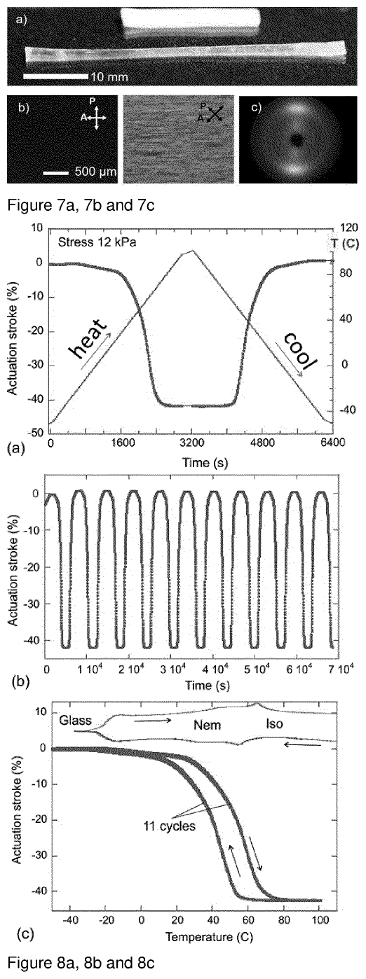

100% elongation of the sample is deemed sufficient to impart the fully uniaxial monodomain alignment to the xLCE, as confirmed by FIG. 7. FIG. 7a illustrates the uniaxially aligned monodomain sample and compares it with the initial polydomain xLCE. FIGS. 7b and 7c confirm this uniaxial alignment: FIG. 7b shows a pair of microscopy images between crossed polars, whilst FIG. 7c shows an X-ray image (nematic order parameter Q=0.62).

The programmed alignment is permanent as long the sample temperature is not allowed to raise above 140° C. (see FIG. 6a), when the residual creep would cause a gradual loss of alignment (which increases at even higher temperatures). However, it is possible to re-program the material to a different shape and state of alignment by a subsequent process.

### Example 6

Having programmed the uniaxial monodomain alignment in the 40% crosslinked xLCE, its actuation response to reversible heating and cooling through the nematic-isotropic transition was examined. FIG. 8 illustrates different elements of this test, carried out in the DMA instrument under a low constant stress (of 12 kPa) to ensure the sample is straight and taut.

FIG. 8a focusses on one cycle of heating and cooling, over the range of −50° C. to 90° C. (T_{g}≈−20° C. and T_{c}≈60° C. for the 40% crosslinked xLCE). The sample starts rapid contraction when the temperatures approaches 30° C., and reaches the saturation strain of over 40% at around 70° C. (both values are clearly affected by the dynamics of temperature change). On cooling the cycle reverses. No creep of thermal degradation was expected to occur in the xLCE materials as the temperature never reached the levels where plastic creep might set in.

FIG. 8b illustrates the remarkable stability of this spontaneous contraction-expansion over 11 cycles of temperature. The same 11 cycles of heating and cooling are shown in FIG. 8c as actuation strain against temperature: all heating and all cooling strokes are on top of each other, however, a clear hysteresis of the nematic-isotropic transition can also be seen. To support this observation, FIG. 8c also shows the DSC scans (scaled, in a.u.) on heating and cooling, at the top of the plot, to illustrate where the glass and nematic transitions are in each direction.

The wide separation of the nematic transition and the vitrification temperature, at which the plastic creep starts to occur in the xLCE under stress is the reason for stability of the thermal actuation, and the programmed alignment pattern.

### Example 7

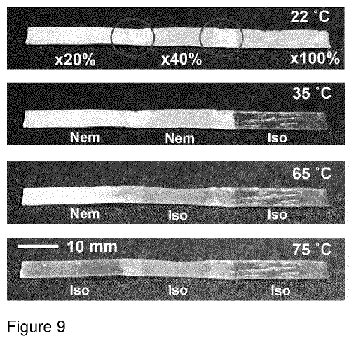

The thermal molding of the xLCEs of the present invention were then demonstrated. Three different xLCE materials (with 20%, 40%, and 100% crosslinking density) were prepared as above into separate strips. The three strips were then molded together into one continuous sample by bringing the separate parts together at the required junctions and subjecting the assembly to high temperature (T=250° C.) and high pressure overnight. The remarkable thermal stability of the thiol-siloxane mesogenic system is noteworthy; few polymers will withstand several hours at 250° C. without any degradation. FIG. 9 illustrates the result of the molding, where it is impossible to distinguish the initial overlap regions in the molded sample (highlighted by circles). Referring to FIG. 9, at room temperature (22° C.) all three sections are in the polydomain nematic state, and so appeared white (i.e. they strongly scatter light). Then, on heating the strip, the sequential phase transitions into the isotropic phase were observed in different sections of the otherwise continuous polymer strip: first the 100% crosslinked section becomes isotropic (i.e. it appears transparent, therefore no longer scatters light), then the 40% section, and finally the 20% section so that the whole strip becomes isotropic by the time the temperature has been raised to 75° C.

This example demonstrates the capacity to mold together different xLCE materials containing exchangeable siloxane bonds and the appropriate catalyst. As such, the xLCEs of the present invention offer rich design options for complicated actuating shapes and constructions for practical applications.

1. A siloxane-based liquid crystalline elastomer, preferably an exchangeable siloxane-based liquid crystalline elastomer, derived from monomers (A1), (B1) and (C1), wherein (C1) is an acyclic or cyclic vinyl siloxane, and (A1) and (B1) have the following formulae: 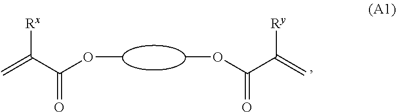
wherein [symbol] is a mesogen, and
R^{x} and R^{Y} are independently selected from hydrogen or substituted or unsubstituted C₁₋₁₂ alkyl; 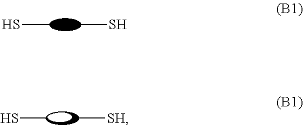
wherein [symbol] is an organic group.

2. (canceled)

3. The siloxane-based liquid crystalline elastomer as claimed in claim 1 having a T_{c} in the range 30 to 150° C., preferably 30 to 125° C.; and/or
a Tᵥ in the range 150 to 300° C., preferably 150 to 280° C.; and/or
a T_{g} in the range −100 to 0° C., preferably −75 to −10° C.; and/or
wherein the gap between T_{c} and Tᵥ is in the range 100 to 350° C., preferably 100 to 300° C.

4-5. (canceled)

6. The siloxane-based liquid crystalline elastomer as claimed in claim 1, wherein monomer (C1) has a formula selected from (C1a) and (C1b): 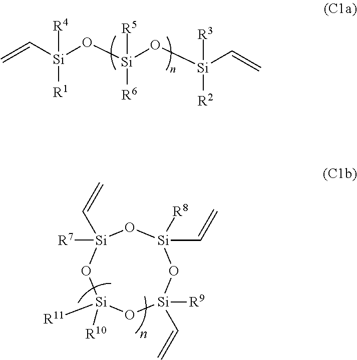
wherein
n is 0 or an integer from 1 to 20; and
each R¹, R², R³, R⁴, R⁵, R⁶, R⁷, R⁸, R⁹, R¹⁰ and R¹¹ are organic groups which may be the same or different, and preferably wherein monomer (C1) is selected from:

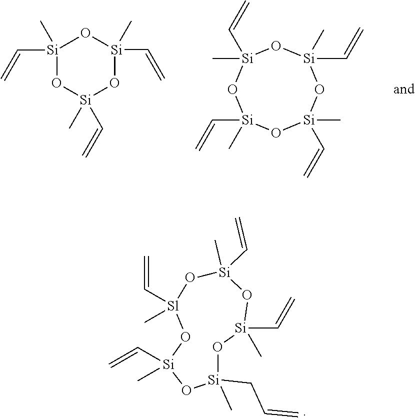

7. (canceled)

8. The siloxane-based liquid crystalline elastomer as claimed in claim 1, wherein in monomer (B1) [symbol] is an aliphatic or aromatic organic group, said organic group optionally containing at least one heteroatom, and preferably wherein monomer (B1) is HS—(CH₂)₂—O—(CH₂)₂—O—(CH₂)₂—SH.

9. (canceled)

10. The siloxane-based liquid crystalline elastomer as claimed in claim 1, wherein [symbol] in monomer (A1) is nematic or smectic, and preferably wherein monomer (A1) is selected from:

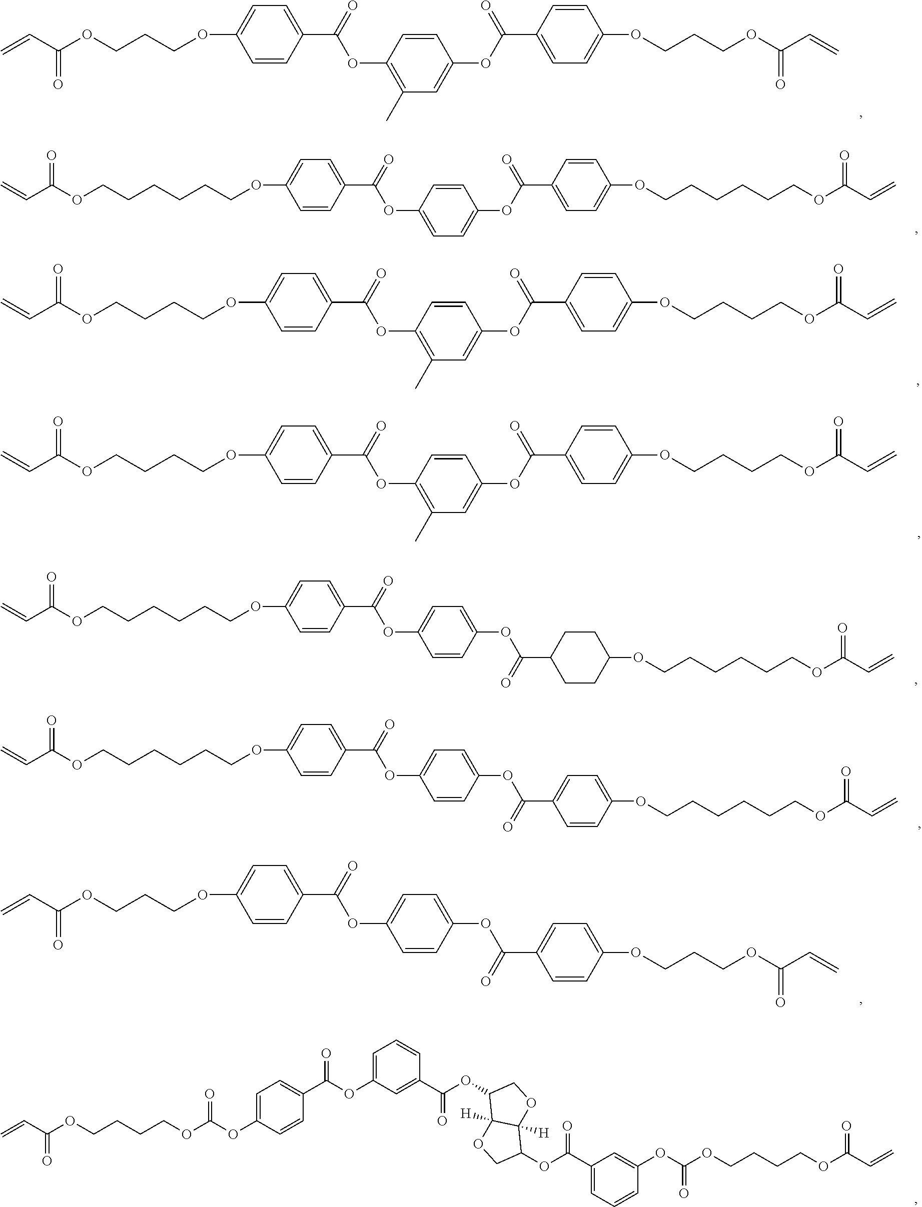

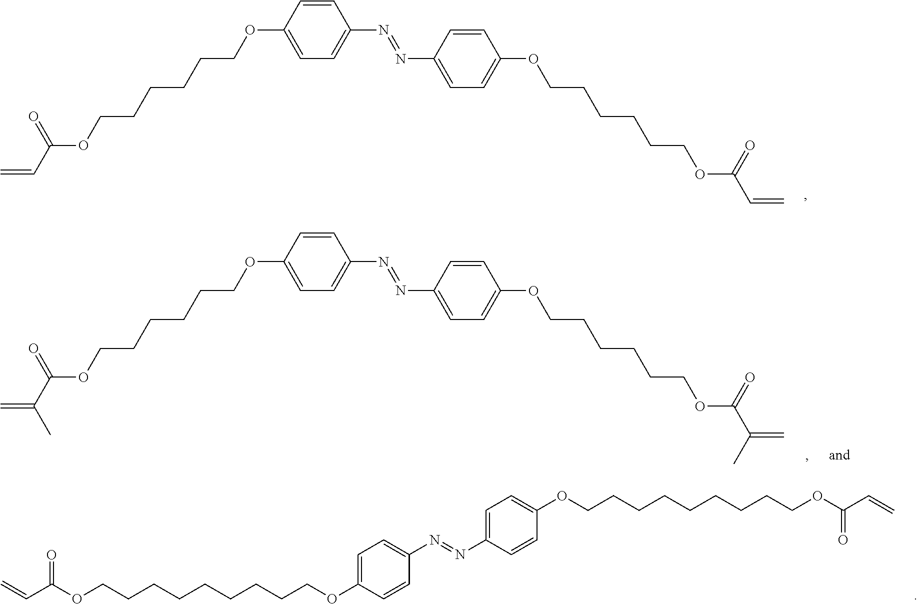

11. (canceled)

12. The siloxane-based liquid crystalline elastomer as claimed claim 1 comprising repeat units of formulae (A), (B), and (Ca) or (Cb):

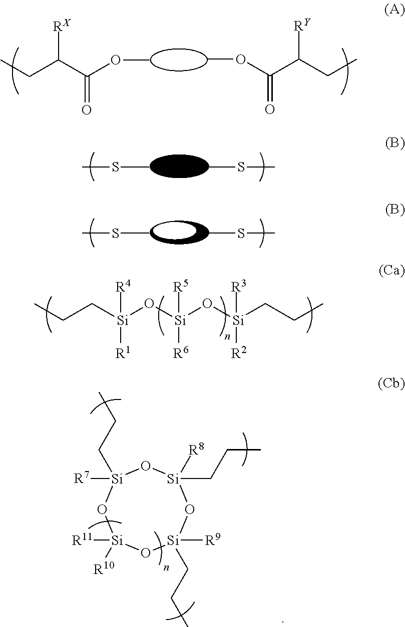

13. The siloxane-based liquid crystalline elastomer as claimed claim 1, having a failure strain of 100 to 500%, and/or wherein the actuation stroke after the fifth heating/cooling cycle is within +/−5% of the actuation stroke after the first heating/cooling cycle.

14. (canceled)

15. A composition comprising a siloxane-based liquid crystalline elastomer, preferably an exchangeable siloxane-based liquid crystalline elastomer, and a catalyst, preferably wherein the catalyst is a base, wherein said siloxane-based liquid crystalline elastomer is derived from monomers (A1), (B1) and (C1), wherein (A1) has a formula selected from 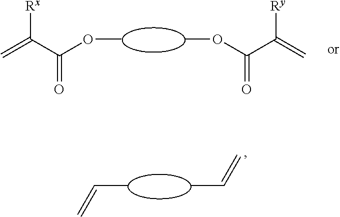
wherein [symbol] is a mesogen, and R^{x} and R^{y} are independently selected from hydrogen or substituted or unsubstituted C₁₋₁₂ alkyl;
(B1) has a formula selected from 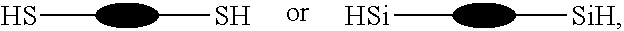
wherein [symbol] is an organic group; and
(C1) is an acyclic or cyclic vinyl siloxane or an acyclic or cyclic thiol siloxane.

16-20. (canceled)

21. The composition claimed in claim 15, wherein said siloxane-based liquid crystalline elastomer comprises repeat units of formulae (A), (B), and (Ca), (Cb), (Cc) or (Cd):
wherein the repeat unit of formula (A) is 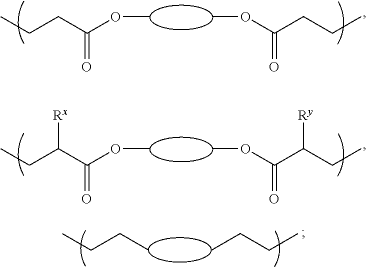
wherein the repeat unit of formula (B) is 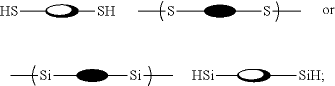
wherein the repeat unit of formula (Ca) is 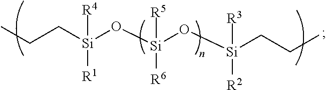
wherein the repeat unit of formula (Cb) is 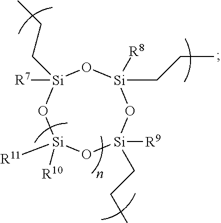
wherein the repeat unit of formula (Cc) is 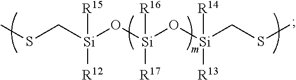
and
wherein the repeat unit of formula (Cd) is

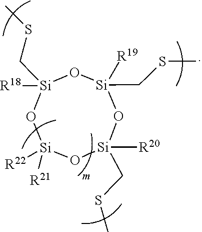

22. (canceled)

23. The method of preparing a composition as claimed in claim 15, preferably conducted in one pot, comprising:
(i) preparing a mixture comprising monomers of each of formula (A1), (B1), and (C1) as defined in claim 15, and a catalyst;
(ii) polymerising the monomers of formula (A1) and (B1) to give an intermediate reaction mixture comprising a thiol-terminated oligomer, an acrylate-terminated oligomer, a vinyl-terminated oligomer, or a silane-terminated oligomer, monomers of formula (C1) and a catalyst; and
(iii) photopolymerizing said intermediate reaction mixture to give said composition; or
(i) preparing a mixture comprising monomers of each of formula (B1) and (C1) as defined in claim 20, and optionally a catalyst;
(ii) photopolymerizing said mixture to give an intermediate reaction mixture comprising a thiol-terminated siloxane, a vinyl-terminated oligomer, or a silane-terminated siloxane, and optionally a catalyst;
(iii) adding monomers of formula (A1) as defined in claim 20, and optionally a catalyst to said intermediate reaction mixture; and
(iv) polymerising said intermediate reaction mixture to give said composition, wherein catalyst is added in at least step (i) or step (iii).

24-26. (canceled)

27. The method of making a moulded article comprising a composition as claimed in claim 15, comprising:
(i) heating the composition to a temperature above the Tᵥ of the siloxane-based liquid crystalline elastomer;
(ii) moulding the composition into a desired shape whilst applying a constant tensile stress to give a moulded composition having alignment (e.g. having a required pattern of alignment); and
(iii) cooling the moulded composition to room temperature to give said moulded article.

28. The method as claimed in claim 27, wherein the step (ii) moulding is selected from shear extrusion (e.g. 3D printing), uniaxial alignment, surface alignment and injection moulding.

29. The method as claimed in claim 27, wherein said step (ii) moulding involves siloxane bond exchange within the siloxane-based liquid crystalline elastomer.

30. (canceled)

31. A moulded article comprising a composition as claimed in claim 15.

32. (canceled)

33. The composition as claimed in claim 15, wherein said siloxane-based liquid crystalline elastomer is derived from monomers (A1), (B1) and (C1), wherein (C1) is an acyclic or cyclic vinyl siloxane, and (A1) and (B1) have the following formulae: 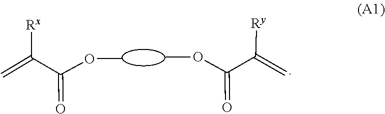
wherein [symbol] is a mesogen, and
R^{x} and R^{y} are independently selected from hydrogen or substituted or unsubstituted C₁₋₁₂ alkyl; 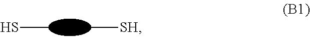
wherein [symbol] is an organic group.

34. The composition as claimed in claim 15, wherein said siloxane-based liquid crystalline elastomer is derived from monomers (A1), (B1) and (C1), wherein (A1) has a formula selected from 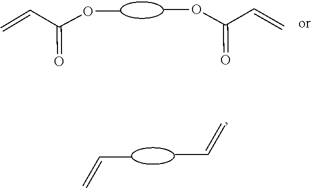
wherein [symbol] is a mesogen;
(B1) has a formula selected from 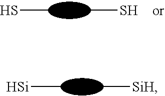
wherein [symbol] is an organic group; and
(C1) is an acyclic or cyclic vinyl siloxane or an acyclic or cyclic thiol siloxane.

35. The composition as claimed in claim 15, wherein said siloxane-based liquid crystalline elastomer comprises repeat units of formulae (A), (B), and (Ca), (Cb), (Cc) or (Cd):
wherein the repeat unit of formula (A) is 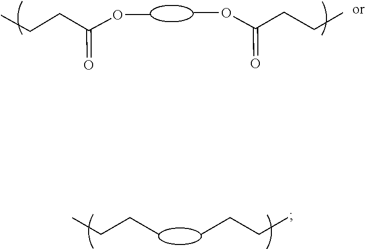
wherein the repeat unit of formula (B) is 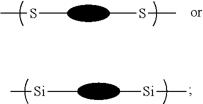
wherein the repeat unit of formula (Ca) is 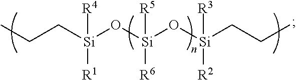
wherein the repeat unit of formula (Cb) is 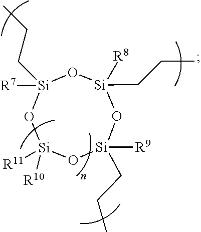
wherein the repeat unit of formula (Cc) is 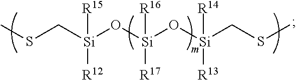
and
wherein the repeat unit of formula (Cd) is

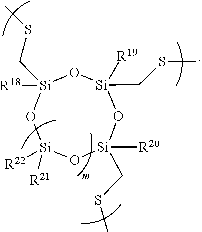

36. The method as claimed in claim 23, comprising:
(i) preparing a mixture comprising monomers of each of formula (A1), (B1), and (C1), wherein (C1) is an acyclic or cyclic vinyl siloxane, and a catalyst: 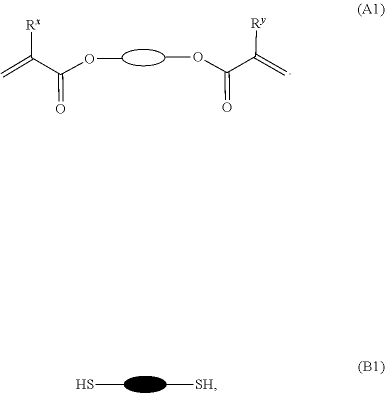
wherein [symbol] R^{x} and R^{Y} are independently selected from hydrogen or substituted or unsubstituted C₁₋₁₂ alkyl;
(ii) polymerising the monomers of formula (A1) and (B1) to give an intermediate reaction mixture comprising a thiol-terminated oligomer, monomers of formula (C1) and a catalyst; and
(iii) photopolymerizing said intermediate reaction mixture to give said composition; or
(i) preparing a mixture comprising monomers of each of formula (B1) and (C1), wherein (C1) is an acyclic or cyclic vinyl siloxane, and optionally a catalyst: 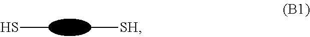
wherein [symbol] is an organic group;
(ii) photopolymerizing said mixture to give an intermediate reaction mixture comprising a thiol-terminated siloxane, and optionally a catalyst;
(iii) adding monomers of formula (A1) and optionally a catalyst to said intermediate reaction mixture: 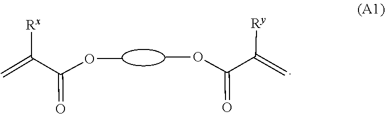
wherein [symbol] , R^{x} and R^{Y} are independently selected from hydrogen or substituted or unsubstituted C₁₋₁₂ alkyl; and
(iv) polymerising said intermediate reaction mixture to give said composition,
wherein catalyst is added in at least step (i) or step (iii).
